(19) United States
(12) Patent Application Publication
(10) Pub. No.: US 2025/0094930 A1
(43) Pub. Date: Mar. 20, 2025

(54) SYSTEM AND METHOD FOR FACILITATING STUDENT ATHLETE RECRUITMENT

(71) Applicant: Commit Sports, LLC, Mesa, AZ (US)

(72) Inventor: Macayla HUFFAKER, Mesa, AZ (US)

(21) Appl. No.: 18/942,249

(22) Filed: Nov. 8, 2024

Related U.S. Application Data
(63) Continuation-in-part of application No. 18/892,267, filed on Sep. 20, 2024.
(60) Provisional application No. 63/584,143, filed on Sep. 20, 2023.

(51) Int. Cl. G06Q 10/1053

(52) U.S. Cl. CPC G06Q 10/1053

(57) ABSTRACT

A system and method for facilitating student athlete recruitment is disclosed the system includes a server having a processor that is communicatively coupled to a memory a storage and a network interface communicatively coupled to a network the server is configured to receive a first message from a first client device the first client device associated with a first user the first user being one of a player user a team user a recruiter user and a fan user the first message includes live scoring data describing a sporting event the server is also configured to identify a game data object within the storage that is associated with the sporting event the game data object is referenced by at least one of a player record and a team record the server is additionally configured to update the game data object to reflect the live scoring data.

### RELATED APPLICATIONS

This application is a continuation of U.S. application Ser. No. 18/892,267 filed on Sep. 20, 2024 which claims the benefit of U.S. provisional patent application 63/584,143, filed Sep. 20, 2023, titled “System and Method for Facilitating Student Athlete Recruitment,” the entirety of the disclosure of which is hereby incorporated by this reference.

### TECHNICAL FIELD

Aspects of this document relate generally to student athlete recruitment.

### BACKGROUND

The recruitment of student athletes by colleges is a complex process requiring significant time, resources, and effort from both the athletes and the colleges involved. It involves scouting, evaluating, and recruiting high school athletes who can perform at the collegiate level, considering athletic ability, academic performance, and character. However, several inherent challenges make this process difficult and inefficient.

High school athletes from smaller schools, rural areas, or less competitive regions often struggle to gain visibility among college scouts. Despite their potential, they may go unnoticed due to limited exposure and access to high-profile competitions, especially in less-publicized sports. These athletes also face difficulties in understanding the recruiting process, knowing which colleges would be a good fit for them, and effectively showcasing their skills and abilities.

From the perspective of the colleges, identifying and evaluating potential recruits can be a labor-intensive and costly process. Scouts must travel extensively to observe athletes in person, incurring significant expenses and time commitments. Additionally, they may have to sift through a high volume of promotional materials and videos, making it hard to assess true capabilities. The process becomes even more challenging when trying to find athletes for specific positions or roles, as this requires a more nuanced understanding of the athlete's skills and potential fit within the team.

Moreover, the traditional recruitment process typically relies heavily on personal networks and relationships, which can limit the pool of potential recruits to those within certain geographies or social circles. This can lead to missed opportunities to recruit talented athletes who fall outside of these networks. Socioeconomic factors also play a role, as not all athletes can afford participation in elite teams or showcases for exposure.

These challenges result in a recruitment landscape that may overlook gifted athletes who could significantly contribute at the collegiate level. Both athletes and colleges could benefit from a more efficient, transparent, and inclusive recruitment process.

### SUMMARY

According to one aspect, a system for facilitating student athlete recruitment includes a server having a processor that is communicatively coupled to a memory, a storage, and a network interface. The network interface is communicatively coupled to a network. The server is configured to receive a first message from a first client device communicatively coupled to the server through the network, the first client device associated with a first user. The first user is one of a player user, a team user, a recruiter user, and a fan user. The first message includes live scoring data describing a sporting event. The server is also configured to identify a game data object within the storage that is associated with the sporting event being described in the first message. The game data object being referenced by at least one of a player record and a team record the server is additionally configured to update the game data object to reflect the live scoring data and receive a second message from a second client device communicatively coupled to the server through the network. The second client device is associated with a second user, different from the first user. The second message includes an approval of the first message or live scoring data describing the sporting event that overlaps at least in part with the live scoring data of the first message. The server is also configured to validate the live scoring data associated with both the first message and the second message upon determination that the second message is in agreement with the live scoring data belonging to the first message, and update the game data object to include validated scoring data. Updating the game data object occurs contemporaneous with the sporting event.

Particular embodiments may comprise one or more of the following features. The at least one of a player record and a team record referencing the game data object may only refer to validated scoring data. An interface of a third client device may be updated to reflect the validated scoring data of the game data object in response to the validation of the live scoring data. The interface of the third client device may be updated to reflect the validated scoring data in real time. The server may be further configured to receive an authorization message from the second user identifying the first user and authorizing the first user to act as a subcoach. Validating the live scoring data associated with both the first message and the second message may further include determining that the first user has been authorized to act as the subcoach and/or also determining that the second user is a team user. The sporting event may involve a first team and a second team. The server may be configured to only allow a single subcoach to be authorized by each team at a time. The authorization for the subcoach may be only valid for that sporting event. The server may be further configured to receive and validate live scoring data from client devices associated with the first team and a subcoach authorized by the first team. The server may be further configured to receive and validate live scoring data from client devices associated with the second team and a subcoach authorized by the second team. The server may be further configured to finalize the validated scoring data as finalized scoring data when the sporting event has concluded. The finalized scoring data may be an average of the validated scoring data validated by the first team and the validated scoring data validated by the second team. The server may be further configured to provide a leaderboard to an interface of a third client device. The leaderboard may be returned by a query over at least a subset of team records and player records within the storage and may include at least a portion of the validated scoring data belonging to the game data object, while the sporting event is occurring. The server may be configured to update the leaderboard on the interface of the third client device to reflect the validated scoring data in real time. The first message may include a location data associated with the first client device. The server may be further configured to confirm the first user is present at the sporting event using the location data associated with the first client device.

According to another aspect of the disclosure, a system for facilitating student athlete recruitment includes a server having a processor that is communicatively coupled to a memory, a storage, and a network interface. The network interface is communicatively coupled to a network. The server is configured to receive a first message from a first client device communicatively coupled to the server through the network. The first client device is associated with a first user, the first user being one of a player user, a team user, a recruiter user, and a fan user. The first message includes live scoring data describing a sporting event. The server is also configured to identify a game data object within the storage that is associated with the sporting event being described in the first message. The game data object is referenced by at least one of a player record and a team record. The server is additionally configured to update the game data object to reflect the live scoring data.

Particular embodiments may comprise one or more of the following features. The server may be further configured to receive a second message from a second client device communicatively coupled to the server through the network. The second client device may be associated with a second user different from the first user. The second message may include an approval of the first message or live scoring data describing the sporting event that overlaps at least in part with the live scoring data of the first message. The server may be configured to validate the live scoring data associated with both the first message and the second message upon determination that the second message is in agreement with the live scoring data belonging to the first message. The server may be configured to update the game data object to include validated scoring data. The at least one of a player record and a team record referencing the game data object may only refer to validated scoring data. An interface of a third client device may be updated to reflect the validated scoring data of the game data object in response to the validation of the live scoring data. The interface of the third client device may be updated to reflect the validated scoring data in real time. The server may be further configured to receive an authorization message from the second user identifying the first user and authorizing the first user to act as a subcoach. Validating the live scoring data associated with both the first message and the second message may further include determining that the first user has been authorized to act as the subcoach and also determining that the second user is a team user. The server may be configured to only allow a single subcoach to be authorized by a team at a time. The authorization for the subcoach may be only valid for that sporting event. The sporting event may involve a first team and a second team. The server may be configured to receive and validate live scoring data from client devices associated with the first team and a subcoach authorized by the first team. The server may be configured to receive and validate live scoring data from client devices associated with the second team and a subcoach authorized by the second team. The server may be configured to finalize the validated scoring data as finalized scoring data when the sporting event has concluded. The finalized scoring data may be an average of the validated scoring data validated by the first team and the validated scoring data validated by the second team. The server may be further configured to provide a leaderboard to an interface of a third client device. The leaderboard may be returned by a query over at least a subset of team records and player records within the storage and may include at least a portion of the validated scoring data belonging to the game data object, while the sporting event is occurring. The interface of the third client device may be updated to reflect the validated scoring data in real time. Updating the game data object may occur contemporaneous with the sporting event. The first message may include a location data associated with the first client device. The server may be further configured to confirm the first user is present at the sporting event using the location data associated with the first client device.

The foregoing and other aspects, features, and advantages will be apparent to those artisans of ordinary skill in the art from the DESCRIPTION and DRAWINGS, and from the CLAIMS.

Aspects and applications of the disclosure are described in the drawings and the detailed description below. Unless specifically noted, it is intended that the words and phrases in the specification and the claims be given their plain, ordinary, and accustomed meaning to those of ordinary skill in the applicable arts. The inventor is fully aware that they can be their own lexicographers if desired. The inventor expressly elects, as its own lexicographer, to use only the plain and ordinary meaning of terms in the specification and claims unless clearly stated otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented but have been omitted for purposes of brevity.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Finally, while this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

### BRIEF DESCRIPTION OF THE DRAWINGS

The disclosure will hereinafter be described in conjunction with the appended drawings, where like designations denote like elements, and:

FIG. 1 is a schematic system view of a student athlete recruitment system;

FIG. 2 is a schematic view of a storage belonging to a student athlete recruitment system;

FIG. 3A is a schematic process view of a method for facilitating student athlete recruitment by obtaining and validating live scoring data;

FIG. 3B is a schematic process view of a method for finalizing scoring data;

FIG. 3C is a schematic process view of a method for providing a real-time leaderboard;

FIGS. 4A-30B are various views of user interfaces for a client device interacting with a student athlete recruitment system; and

FIG. 31 is a schematic view of hardware environments that can be used to implement a student athlete recruitment system.

### DETAILED DESCRIPTION

The recruitment of student athletes by colleges is a complex process requiring significant time, resources, and effort from both the athletes and the colleges involved. It involves scouting, evaluating, and recruiting high school athletes who can perform at the collegiate level, considering athletic ability, academic performance, and character. However, several inherent challenges make this process difficult and inefficient.

High school athletes from smaller schools, rural areas, or less competitive regions often struggle to gain visibility among college scouts. Despite their potential, they may go unnoticed due to limited exposure and access to high-profile competitions, especially in less-publicized sports. These athletes also face difficulties in understanding the recruiting process, knowing which colleges would be a good fit for them, and effectively showcasing their skills and abilities.

From the perspective of the colleges, identifying and evaluating potential recruits can be a labor-intensive and costly process. Scouts must travel extensively to observe athletes in person, incurring significant expenses and time commitments. Additionally, they may have to sift through a high volume of promotional materials and videos, making it hard to assess true capabilities. The process becomes even more challenging when trying to find athletes for specific positions or roles, as this requires a more nuanced understanding of the athlete's skills and potential fit within the team.

Moreover, the traditional recruitment process typically relies heavily on personal networks and relationships, which can limit the pool of potential recruits to those within certain geographies or social circles. This can lead to missed opportunities to recruit talented athletes who fall outside of these networks. Socioeconomic factors also play a role, as not all athletes can afford participation in elite teams or showcases for exposure.

These challenges result in a recruitment landscape that may overlook gifted athletes who could significantly contribute at the collegiate level. Both athletes and colleges could benefit from a more efficient, transparent, and inclusive recruitment process.

Contemplated herein is a system and method for facilitating student athlete recruitment. The contemplated system provides a platform for athletes to showcase their skills, allow colleges to easily search for and evaluate potential recruits, and streamline the overall recruitment process. The system increases the visibility of the athletes, allowing those with exceptional skills to be recognized, even in circumstances where they might otherwise be looked over by a recruiter, according to various implementations. The contemplated system addresses the problems inherent in the traditional recruitment process, and provides a novel solution that benefits both student athletes and colleges.

One aspect that sets the contemplated system apart from other efforts to facilitate recruitment is that live scoring stats from game play are sent directly to the profiles of the individual players and their teams. Having this live data is beneficial to a recruiter watching the game. Additionally, live scoring data may further engage the local fans, which can result in increased discussion and content (e.g., photos, videos, etc.) being posted online. According to some implementations, the contemplated system also facilitates linking to, and even hosting this type of content, further enriching the visibility of the athletes.

It should be noted that while much of the following disclosure, and the accompanying figures, is done in the context of an implementation of the contemplated system and method that is focused on softball, the system may be adapted for use with any other sport where statistical information can be generated for an athlete. In some implementations, the system may be limited to a single sport. In other implementations, the system may be used to promote and track athletes across multiple sports, within the same framework.

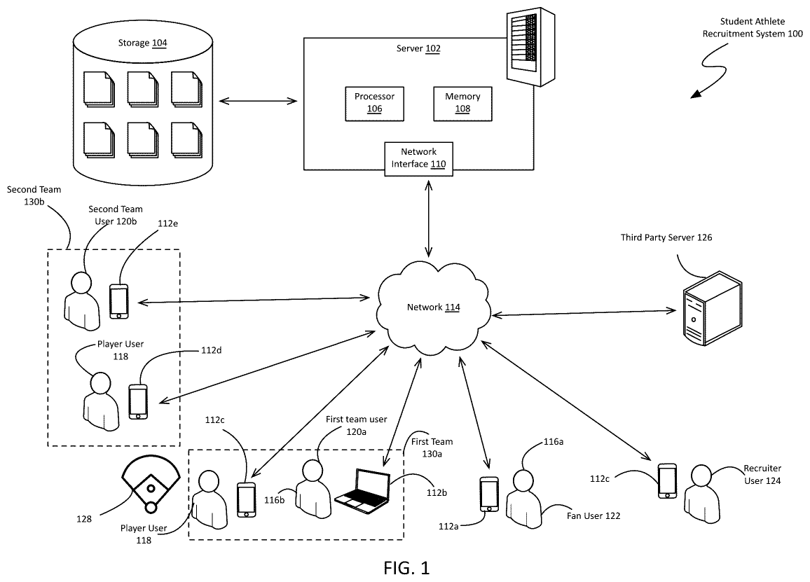

FIG. 1 is a schematic view of a non-limiting example of the contemplated student athlete recruitment system 100 (hereinafter “recruitment system 100” or “system 100”). As shown, the recruitment system 100 comprises a server 102 and a storage 104. The server 102 is communicatively coupled, through a network 114 (e.g., the Internet, etc.) to a plurality of client devices 112 associated with various types of users including, but not limited to, player users 118, team users 120 (e.g., official team representatives, managers, coaches, etc.), fan users 122 (e.g., parents, students, etc.), and recruiter users 124. In some implementations, the system 100 may also be communicatively coupled to one or more third party servers 126, as will be discussed below.

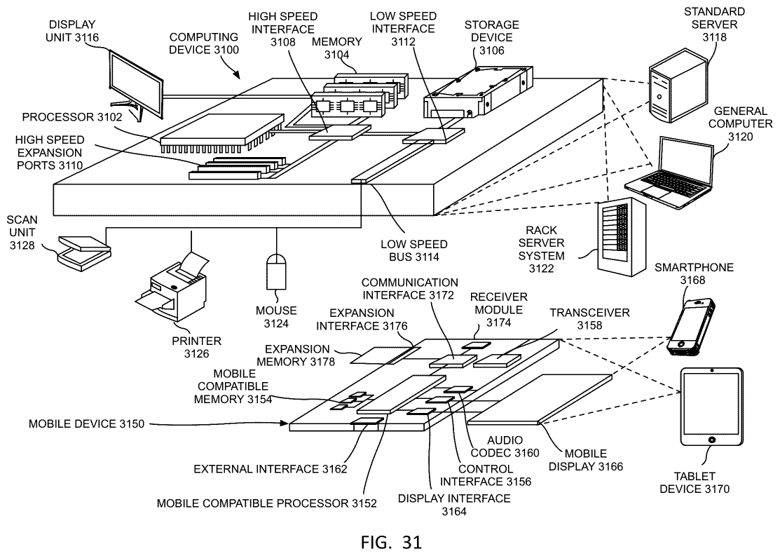

According to various implementations, the recruitment system 100 comprises a server 102. The recruitment system 100 may be implemented in a variety of hardware and/or execution environments. As shown, the recruitment system 100 comprises a processor 106 communicatively coupled to a memory 108, and a network interface 110. In some implementations, the recruitment system 100 maybe be implemented on a discrete computing device, such as a server 102. For example, in some implementations, the recruitment system 100 may operate on a single device, such as specific computing device 3100 of FIG. 31.

It should be noted that although the non-limiting example of the system 100 shown in FIG. 1 portrays the server 102 as being implemented on a rack server system (e.g., rack server system 3122 of FIG. 31, etc.), in other implementations the server 102 may be implemented on other device types including, but not limited to, a standard server (e.g., standard server 3118 of FIG. 31, etc.), and a general computer (e.g., general computer 3120 of FIG. 31, etc.).

In other implementations, the recruitment system 100 may be implemented in a distributed computing environment, being spread across two or more computing device each having its own processor 106 and memory 108. In still other implementations, the recruitment system 100 may be implemented in a virtualized or container-based environment, as is known in the art.

The contemplated recruitment system 100 also comprises a storage 104. In some implementations, the server 102 may be communicatively coupled to the storage 104 through a network 114. In other implementations, the storage 104 may be localized with (e.g., internal to, etc.) the server 102. In other implementations, the storage 104 may be distinct from the server 102. In still other implementations, the storage 104 may be remote to the server 102 (e.g., executed in a cloud environment, etc.).

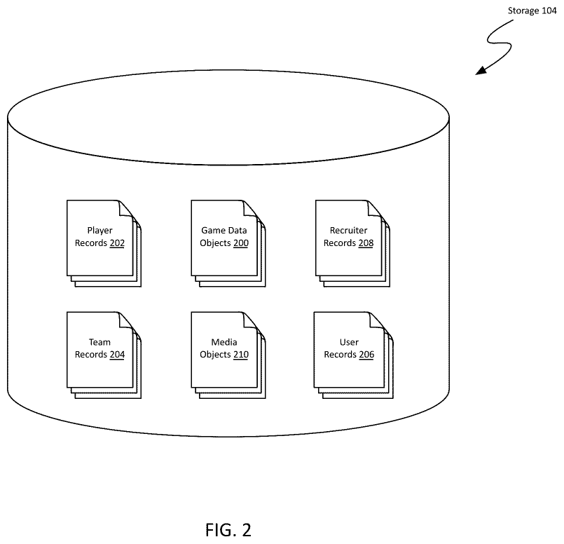

According to various implementations, the storage 104 is used to store various data objects or records used by the system 100, including but not limited to player records, team records, recruiter records, fan records, media objects, game data objects, other user objects, and the like. The storage 104 and associated data objects will be discussed in greater detail with respect to FIG. 2.

In the context of the present disclosure and the claims that follow, a storage 104 may be any form of computer accessible storage 104, including but not limited to a file server 102, a cloud storage 104, a local hard drive, and the like. According to various implementations, the storage 104 is structured as a database. The database may be implemented in any architecture known in the art, such as NewSQL, NoSQL, and the like. It should be noted that there are also implementations where the system 100 does not have a database, and all the storage 104 and retrieval operations discussed below are performed entirely within the memory 108 of the server 102.

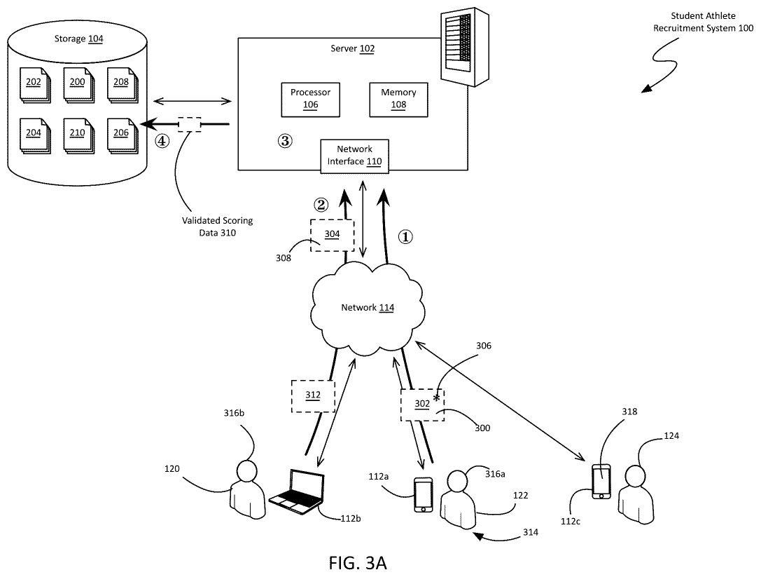

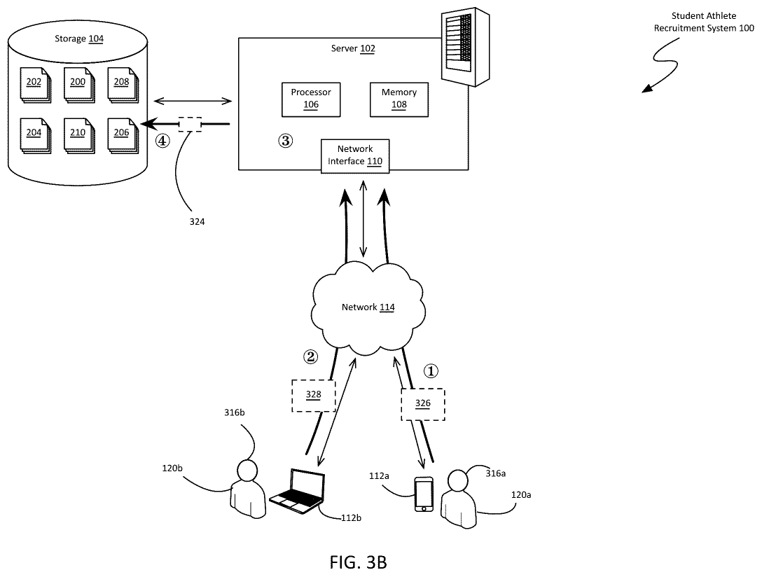

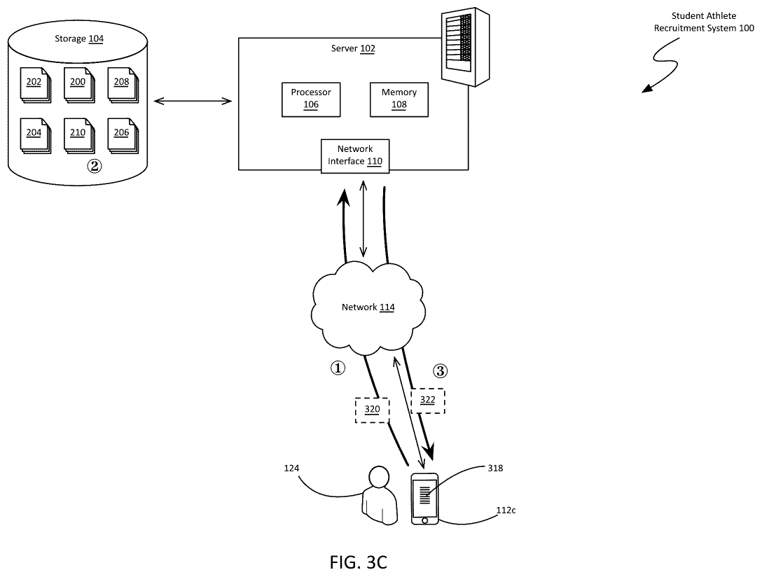

According to various implementations, users interact with the recruitment system 100 through client devices 112 that are communicatively coupled to the recruitment system 100 through a network 114 (e.g., LAN, WAN, Internet, virtualized network, blockchain network, etc.). As a specific example, in one implementation the client devices 112 may interact with the server 102 through a blockchain network, which may be advantageous when relying on different sources for live scoring data. A blockchain network and immutable ledger may be used to safeguard against faulty data, and may speed up establishing trust, resulting in quicker posting of verified live updates to player/team statistics. Other implementations may perform verification using other means, or not at all, as will be discussed below with respect to FIG. 3A.

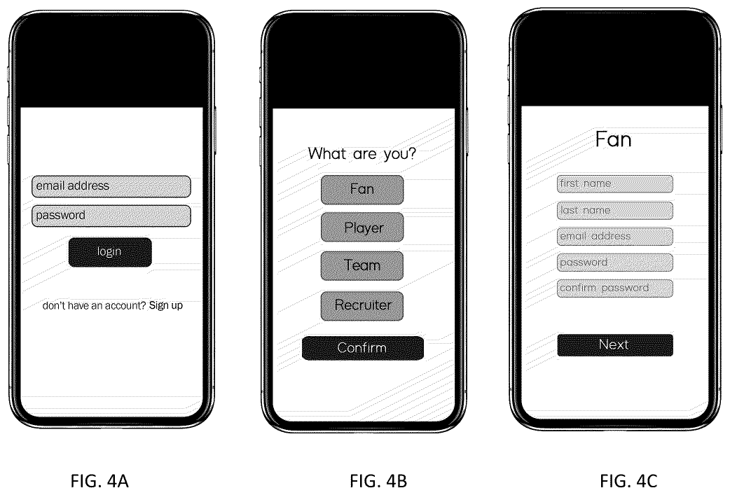

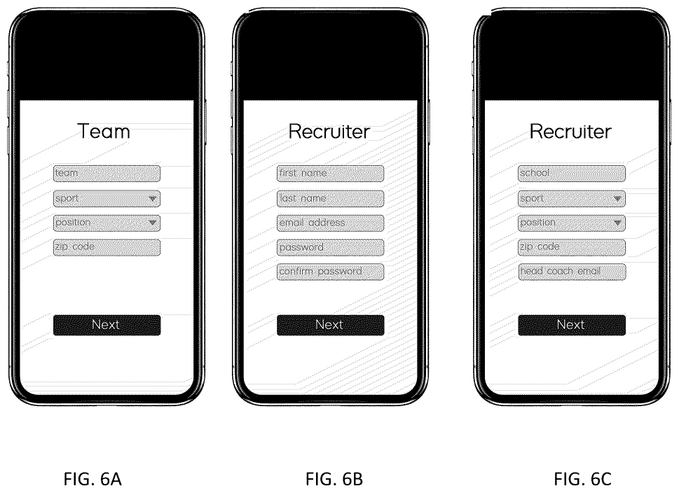

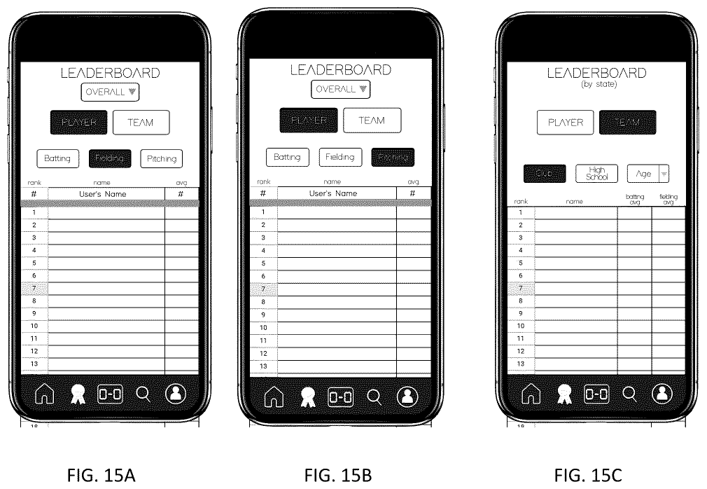

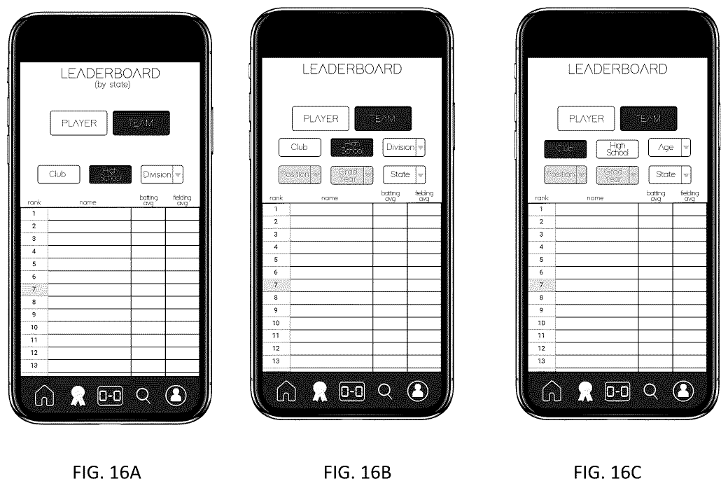

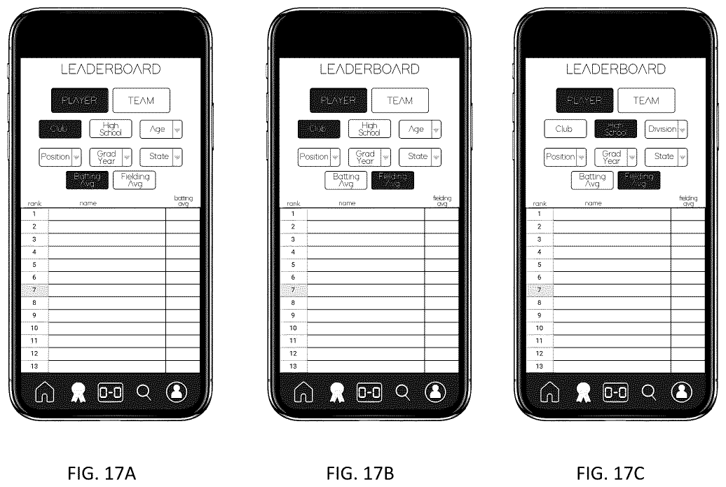

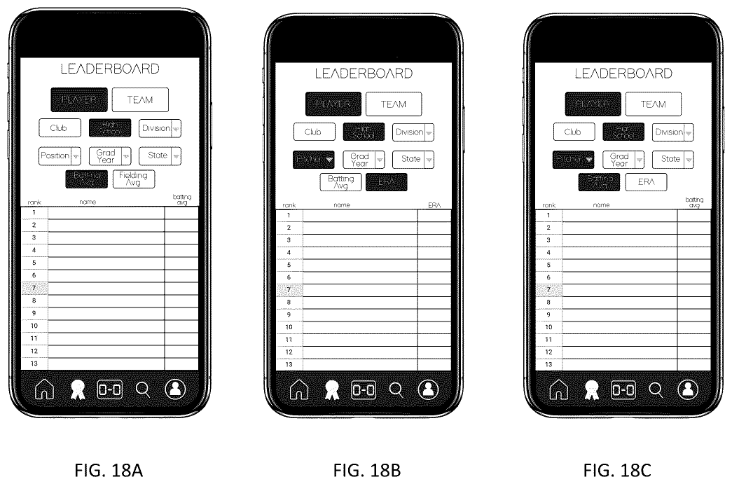

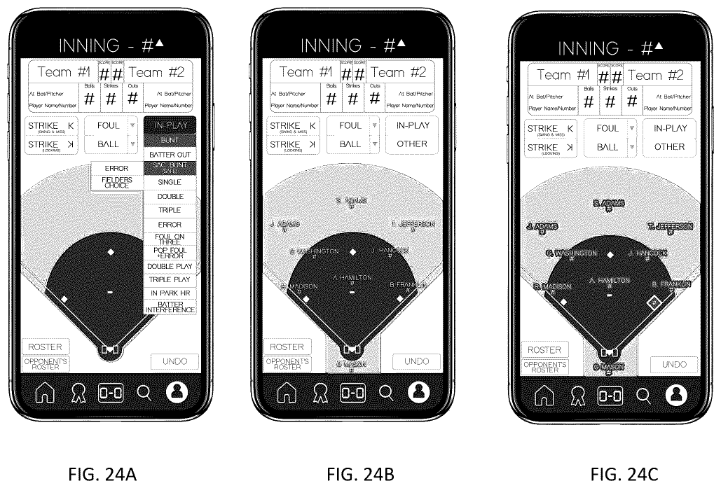

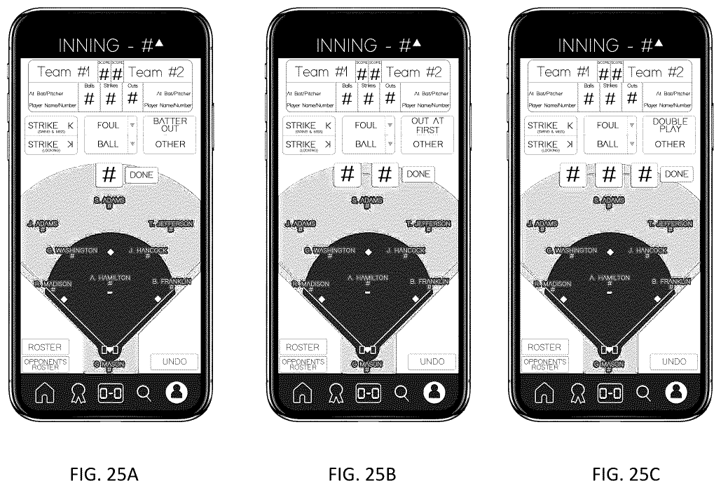

A user may interact with the server 102 using a client device 112, according to various implementations. In the context of the present description, a client device 112 is a device configured to display or otherwise provide an interface through which individuals or systems may interact with the recruitment system 100. While much of the present disclosure focuses on implementations comprising an application running on a mobile device (see exemplary user interfaces in FIGS. 4-30), other implementations may make use of other or additional interfaces. Exemplary interfaces include, but are not limited to, websites or a web interface, APIs, mobile and/or desktop applications, and the like. The client device 112 itself may be any of various computing platforms, such as mobile devices (e.g., phone, tablet, etc.), desktop devices (e.g., terminal, laptop, etc.), and embedded systems, according to various implementations.

In the context of the present description and the claims that follow, a client device 112 (e.g., first client device 112a, second client device 112b, third client device 112c, etc.) may be said to be associated with a user (e.g., first user 116a, second user 116b, third user 116c, etc.) when that client device 112 is accessing the server 102 on behalf of, using the credentials or login information of, and/or having that user's account active on the device. This association does not necessarily mean ownership, simply the use or capacity for use of the recruitment system 100 on behalf of said user, according to various embodiments.

As shown in FIG. 1, various users, or types of users, may interact with the server 102 through their respective client devices 112. These user types may include player users 118, team users 120, fan users 122, and recruiter users 124, according to various implementations. Each will be discussed, in turn.

According to various embodiments, two types of users can “belong” (i.e., active participation in a sport) to a team 130: player users 118 and team users 120. Player users 118 may be associated with more than one team 130 (e.g., a student who plays on the high school team and on a local club team, etc.). As shown in FIG. 1, the first team 130a comprises a first team user 120a and the second team 130b comprises a second team user 120b. The player user 118 is plays for and is associated with (within the system 100) both the first team 130a and the second team 130b, as shown.

In the context of the present description and the claims that follow, a player user 118 is an individual who participates in a sport (e.g., plays in a sporting event 128, etc.) that is being monitored (e.g., statistics gathered and reported, etc.) and promoted through the contemplated recruitment system 100. Within the system 100, a player user 118 is represented by a player record, which will be discussed further in the context of FIG. 2.

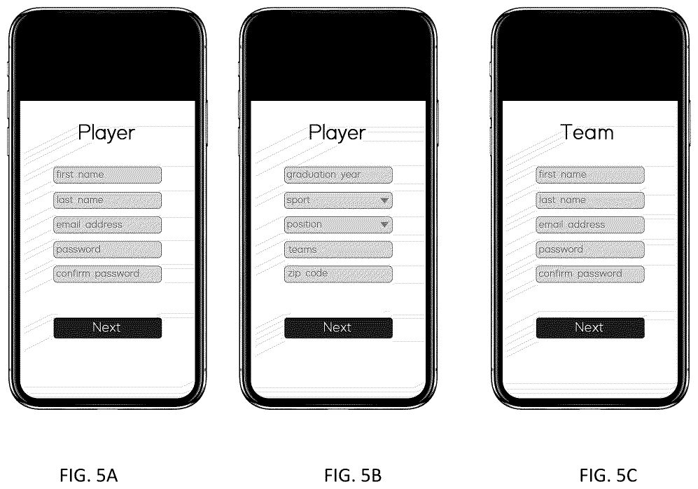

Put differently, the contemplated system 100 is designed to increase the visibility and recruitment prospects of player users 118. In some implementations, a player user 118 may represent an individual who is both a participant, and an individual who has registered with the contemplated system 100 (see FIGS. 5a and 5b for exemplary player onboarding user interfaces). In other implementations, a player user 118 may simply be a participant of a sport within an organization (i.e., team 130, etc.) that is being tracked with the contemplated system 100; a player record may be created for all participants, independent of whether they have participated in the onboarding process (e.g., chosen a password, etc.), as they will be listed as a member of a team and a participate in games that are visible through the contemplated system 100. As an option, in some implementations, the information gathered and stored for players who have not created or activated an account may be limited, in comparison to other player users 118 who are active participants in the recruitment system 100.

It should be noted that while this system 100, as disclosed, is focused on facilitating the recruitment of student athletes (e.g., high school, club, etc.) into college sports, it may be adapted for use in sports recruiting in other contexts, outside of college.

In the context of the present description and the claims that follow, a team user 120 is an individual who is an official representative of, or otherwise authorized by, a team 130 (i.e., a school team, a club team, etc.). Examples may include, but are not limited to, coaches, assistant coaches, trainers, managers, school administrators, club managers, and the like. A team user 120 can post items on a team page or profile. In some implementations, a team user 120 may be able to submit and/or validate live scoring data using a client device 112.

In the context of the present description and the claims that follow, a fan user 122 is a user who has access to at least some aspects of the contemplated system 100, but is not a player, an official representative of a team, or a recruiter. Examples include other students, parents, and other interested individuals. Like other user types, a fan user 122 may be able to follow various players and teams, making their statistics readily available and adding to their running tally of “followers”, according to various implementations. In some implementations, a fan user 122 may be able to submit live scoring data using a client device 112. In other implementations, a fan user 122 may be able to submit media (e.g., photos, video, etc.) related to a sporting event 128. In still other implementations, a fan user 122 may be limited to accessing data, with limited to zero ability to contribute data to the system 100.

In the context of the present description and the claims that follow, a recruiter user 124 is an individual that is officially part of the recruiting effort of a college or other institution (e.g., a recruiter, a scout, a member of the athletic department of a college, etc.). In some embodiments, a recruiter user 124 has access to more granular information than the other user types, as will be discussed in the context of leaderboards available to recruiters shown in FIGS. 3C and 17-18c, below.

Each of these users are represented within the system 100 by one or more data objects (e.g., database record, digital file in a file system, etc.) that serve as profiles. For example, in one implementation an athlete may have a player record that contains their stats, and a standard user or fan record that contains things like their app preferences and list of who they are following. The contents of these different profiles or records will be discussed in greater detail with respect to FIG. 2.

In some implementations, the system 100 may be accessible to additional user types, or to different entities. For example, in some implementations, a representative of the governing body for a sport within a particular jurisdiction may have access as a user, and may have the ability to certify game outcomes. As another example, in some implementations, a former player may be a special type of user, somewhere between player and fan. For example, a former player (or “alumni”) may be able to access all the information available to a fan, but also see their own statistics beside the data for the current team/players (e.g., to see where they would be on the leaderboard today, etc.). In still other implementations, additional user types may be defined, and given their own set of abilities and access rights.

In some implementations, the server 102 may also be communicatively coupled, through the network 114, to one or more third party servers 126. These third party servers 126 may provide additional information not available from the various users, or information that would be of interest to said users. Examples of such information includes, but is not limited to, weather data during sporting events 128, local and/or national records for a particular sport, official footage of a sporting event 128 (e.g., footage captured by cameras installed or operated by the sports venue, footage captured by the media, etc.), official rules for a particular sport in a particular jurisdiction, identities and performance of former players from a jurisdiction who were previously recruited, data such as posts and media linked to and stored by a social media service, and the like.

Some third party server 126 integrations may be persistent. Other third party integrations may be temporary. As a specific example, in a year with a summer or winter Olympic competition, users may have the option of seeing recent performances in the same or similar sporting events, alongside the statistics of the local players/teams.

FIG. 2 is a schematic view of the storage 104 of the contemplated system 100, according to various embodiments. As previously discussed, the various individuals and groups that interact with the system 100 at various levels are all represented by data objects referred to as profiles. Those skilled in the art will recognize that a data object may be implemented within a storage 104 in a number of ways, and is not limited to a particular architecture or format.

According to various embodiments, each data object or record in the storage 104 has a unique object identifier by which it may be referred to. In some embodiments, the inclusion of an object's identifier in a data field of another data object may embed the data within that object, as though it was written in the host object. In other embodiments, the use of the unique identifiers may be limited to providing a link to a related object that must be requested to obtain information that it holds.

Again, it is important to note that the following is a discussion of how the data is organized in the storage 104 according to some, not all, embodiments. In other embodiments, this information may be organized in other ways, according to different protocols known in the art. In other embodiments, the contemplated system 100 may be implemented with different data objects that may have additional and/or different data fields. Those skilled in the art will recognize that the ideal storage 104 architecture to use will depend on a number of factors including, but not limited to, the size of the user base and the intended execution environment for the methods contemplated herein.

As shown, the storage 104 may comprise a plurality of game data objects 200. Each game data object 200 describes a discrete sporting event 128 (e.g., a game, a meet, etc.). In some embodiments, the architecture of the game data object 200 (and the system 100 itself) may be limited to sporting events 128 involving two opposing teams 130, with each team 130 having players. In other embodiments, the game data objects 200 may be flexible, and allow for sporting events 128 involving multiple participants who may be affiliated with one of many participating teams 130, or no teams 130 at all. For example, a tournament or meet that involves three or more high schools competing in multiple events simultaneously. As another example, a race (e.g., running, biking, rowing, etc.) that is not strictly limited to student athletes, but has student athletes participating.

According to various embodiments, a game data object 200 may comprise, in addition to a unique identifier, a description of the circumstances or context of the sporting event 128. This information may include, but is not limited to, the time and date of the sporting event 128, the location of the sporting event 128 (e.g., address, venue name, host school name, city, county, school district, GPS coordinates, etc.), the type of sporting event 128 (e.g., regular season, play-off, etc.), game officials (e.g., name and/or registration numbers for officials, referees, umpires, etc.), and the like.

The game data object 200 also comprises data concerning what happened during the game, according to various embodiments. This data may be obtained as live scoring data from one or more client devices 112, and/or from an authorized source after the sporting event 128 is over. In some embodiments, the game data object 200 may indicate the source of the sporting event data (e.g., name of scorer(s), unique identifier of the profile or account or record associated with each scorer, etc.). The actual information that is captured depends on which sport is being played, but may include any statistical information that may be of interest to a recruiter user 124 for recruiting purposes. In some embodiments, the data stored in the game data object 200 may also include information that is not strictly used for recruiting, but may be of interest to other users such as player users 118, team users 120, and/or fan users 122.

According to various embodiments, the information about the sporting event 128 stored in the game data object 200 includes, but is not limited to, the identity of the players (e.g., name, uniform number, unique identifier of their player record 202, etc.), their role in the sporting event 128 (e.g., position, event, weight class, etc.), and their performance. The performance of a player may be reflected with a wide range of statistics and observables; according to various embodiments, it may include anything that may be of use in the recruiting process, or is otherwise of interest.

In some embodiments, the game data object 200 may indicate cumulative information for the sporting event 128, such as the current score or the overall performance of each player. In other embodiments, the information may be segmented according to time periods associated with that particular sport (e.g., innings, quarters, periods, etc.). In still other embodiments, the information may have even more granularity, being a record of chronological events (e.g., by ordering, using time stamps, etc.) submitted as live scoring data. This time data may be used to recreate the order of each incident observed during the game. This may provide insight otherwise unavailable from cumulative statistics, such as illustrating how a player handles certain events like an error (e.g., does one mistake set off a chain of mistakes, can the player recover from a mistake and regain focus to perform, etc.).

As will be discussed below, in some embodiments, information obtained from potentially biased or inaccurate sources may be verified using a variety of means. In some embodiments, the game data object 200 may reflect how (and which) information was verified.

Other information that a game data object 200 may contain includes, but is not limited to, links to related media stored as a media object 210 within the storage 104 or stored on a third party server 126, rare events that occurred (e.g., a record being broken, etc.), weather information (e.g., temperature, wind, etc.), distance traveled by each team to the venue, and the like. In some embodiments, a recruiter may be tagged or otherwise noted when they are present at a game and interacting with the system 100 using their client device 112. In other embodiments, the presence of a recruiter may be hidden, at their discretion or as a policy.

A player record 202 is a data object that stores information about a player. “Player record” may also be used to describe certain user interface elements that inform users about a particular player, but for the purposes of the present discussion, player record 202 will refer to the data object. In some embodiments, they may be essentially the same, with anything stored within the player record 202 data object being accessible through a player record user interface element.

In some embodiments, a player record 202 (again, player record 202 hereinafter referring to the data object) may contain information related to a player user 118 account (e.g., username, password, etc.). In other embodiments, that information may be managed in a separate manner, such as a fan or user record 206 that is common to all users and represents a baseline set of information regarding the nature of that user's interaction with the system 100 (e.g., preferences, social media accounts, contact information, username, password, etc.).

According to various embodiments, the player record 202 may also comprise information about the player that is not directly related to their performance statistics, but may still be of interest to a recruiter. Examples of such information include, but are not limited to, biographical data (e.g., player's history in the sport, awards, achievements, birthplace and age, geographic data such as city or state or school district, etc.), academic information (e.g., anticipated graduation year, GPA, awards, club affiliation, testing scores, etc.), future plans (e.g., commitments to future schools/teams, etc.), and the like.

According to various embodiments, a player record 202 may contain information concerning one or more social media accounts belonging to the player. This may be used to allow recruiters to see the player's social media presence, which can sometimes give insight into a player in ways not otherwise possible. In other embodiments, social media information may be stored in a fan or user record 206.

In some embodiments, users (e.g., player users 118) can “follow” other users such as players, teams, and recruiters. The player record 202 may store a list of accounts being followed, used to populate the player's interface when accessing the system 100 through a client device 112. In other embodiments, this may instead be stored in a user record 206, leaving the player record 202 to focus on the things not found in team, fan, or recruiter records. This may be advantageous, as these two objects may have different availability needs.

A player record 202 may also comprise links to media (e.g., media hosted externally, media objects 210 within the storage 104, etc.) such as photos and video that showcase the player and their skills in the sport. The player may post this media themselves. In some embodiments, the media may also include media posted by someone else in which the player is tagged or otherwise identified.

In some embodiments, the player record 202 may also link to other types of data objects, such as documents (e.g., awards, transcripts, news articles, etc.). Also, in some embodiments, the system 100 may provide a platform for a player to submit posts, like a blog or similar social media. The player record 202 may contain these posts, in some embodiments. In other embodiments, the posts may be stored as a separate object and pointed to or otherwise linked to by the player record 202.

The player record 202 contains or references the statistical data that describes the player's performance that would be of interest to a recruiter. In some embodiments, this may be limited to a single sport, while in other embodiments the system 100 may be configured to increase player visibility in multiple sports.

A player user 118 may be associated with more than one team 130 (e.g., a club team and a school team, etc.), which may be reflected in the player record 202. In some embodiments, a player's statistics may reflect their performance in a sport across multiple teams, while in other embodiments, a player's performance may be separable, such that a recruiter can see their relative performance in the various contexts in which they play (e.g., club play vs school play, etc.).

The primary purpose of the player record 202 is to track the performance of a player user 118 such that it may be presented to a recruiter user 124. The methods used, and the formats, are like those used to track the statistics of a team 130 within a team record 204 (though the statistics being tracked may be different), and are best discussed together, after an introduction to the team record 204.

The team record 204 is like the player record 202, except it is promoting a team 130 rather than a single player user 118. Like the player record 202, a team record 204 will contain identifying information (e.g., team name, school name, school district, club name, coaches, city, state, county, etc.), as well as information not directly linked to the current performance of players, but may still be of interest to a recruiter user 124 or fan user 122. Examples include, but are not limited to, past accomplishments (e.g., state titles, awards, tournament performances, etc.), distinguished alumni who have gone on to college or professional sports (e.g., names, links, articles, media, etc.), team history, coach background, and the like.

The team record 204 will comprise a roster of current player users 118 affiliated with the team 130. In some embodiments, this may include links to player records 202 for each player user 118 (e.g., the unique identifier or other link specific to the architecture of that embodiments storage 104, etc.). In other embodiments, where players can opt out (or must explicitly opt in) to participation in the system 100, the team record 204 may only identify players who are participating in the system 100, along with said linking information.

Like player records 202, fan or user records 206, and recruiter records 208, a team record 204 can follow other teams 130, player users 118, and recruiter users 124, according to various embodiments. In some embodiments, this is reflected in the team record 204, while in others it may be described inside a user record 206 for the team 130 as a whole. As a reminder, the team user 120 is an individual, while a team 130 is an organization made up of athletes, coaches, and the like. All of this discussion of profiles or records is in reference to data objects within the storage 104 of the system 100. Team records 204 may also link to media objects 210 such as photos and videos, chosen by a team user 120 to highlight the team 130, spotlighting their triumphs, good plays, and MVPs from sporting events 128. In some embodiments, the team record 204 may also comprise information about one or more team social media accounts, while in other embodiments it may be in a user record 206 associated with the team 130.

A primary purpose of the contemplated system 100 for facilitating student athlete recruitment is to increase the visibility of the student athletes, making it easier for them to get the attention of college recruiters, and also to assist those recruiters in finding the players they are looking for. Statistics play an important role in the recruitment process, providing a way for recruiters to sift through many players and quickly identify those who may be potential recruits. According to various embodiments, the system 100 contemplated herein tracks the statistics of both individual player users 118, and teams 130 as a whole.

Which specific statistics are tracked will vary from sport to sport, but examples include, but are not limited to, times, points earned, distances, averages, places, rankings, weights, wins, and the like. According to various embodiments, the system 100 may be adapted to collect and track any metric associated with a sport that can be quantified or reduced to a value or expression.

As previously stated, the contemplated system 100 is advantageous over conventional recruitment and promotion systems because it can receive live scoring data from client devices 112, which goes directly into the statistics for a player user 118, as the sporting event 128 is happening. In some embodiments, that data goes directly into the statistics for a team 130 at the same time, while in other embodiments the team statistics may be updated in response to an event (e.g., a change in a player's statistics, the final score of a sporting event 128 being verified, an interval of time has elapsed, etc.).

In some embodiments, the player record 202 is used to identify the sources of statistics or data on which the statistics are based, while the statistics themselves (and/or the data some statistics are based upon) are stored in one or more game data objects 200. This way, as the game data object 200 gets updated with live scoring data, those changes are immediately reflected on the player record 202 since it is referencing the relevant game data objects 200 rather than duplicating the information. In other embodiments, all the statistics may be recorded in the player record 202. Put differently, live scoring data may be used to update the player record 202 as updates arrive.

In still other embodiments, the player record 202 may contain all settled statistics (i.e., statistics from sporting events 128 that are over and finalized) as well as a link to a game data object 200 for a game that is in progress or not settled. Any requests within the system 100 for that player's statistics (e.g., a user has navigated to that player on their client device 112, a current leaderboard has been requested by a client device 112, etc.) will result in the system 100 pulling the current statistics for that player from the linked game data object 200 and combining them with the settled statistics, which is then presented in response to the request. In some embodiments, including the non-limiting examples depicted in the Figures, a player record 202 has links to the game data objects 200 for all the sporting events 128 they have participated in; their statistics are recalculated upon request, using the latest data for all relevant game data objects 200. This makes it possible to update the player records 202 with the live game data while the game is being played. In some embodiments, this update is done and the new data is pushed to interfaces on client devices 112 in real-time, as will be discussed below.

In some embodiments, the statistics for a team 130 may also be immediately updated to reflect live scoring data, and handled using any of the methods described for the player statistics. Specifically, in some embodiments, the team statistics may be literally recorded on the team record 204, and updated as new data is received. In other embodiments, the team record 204 may contain a record of settled statistics and a link to a game data object 200 for an active or unsettled sporting event 128, and a request for the team statistics will result in the two being combined. In still other embodiments, the team statistics may be recalculated each time using the links to the team's player records 202 or, in some embodiments, all the game data objects 200 linked to the team, which are found on the team record 204. In some embodiments, the team statistics may be recorded using a different method than the player statistics.

According to various embodiments, a recruiter record 208 is similar to a player record 202 and a team record 204 in a number of ways. The recruiter record 208 will contain identifying information (e.g., recruiter name, school, email, etc.). In some embodiments, the recruiter record 208 may contain information about specific positions the recruiter is trying to fill. Not only does the contemplated student athlete recruitment system 100 increase the visibility of student athletes, but it may also increase the visibility of the recruiting schools or organizations. In some embodiments, the recruiter record 208 may contain information about the school they represent, and its various sports programs for which they are recruiting (e.g., websites, social media, links to videos and photos, etc.).

In some embodiments, a recruiter user 124 must be verified before having access to the system 100 as a recruiter user 124 (and thus have a recruiter record 208 in the storage 104). According to various embodiments, the recruiter user 124 may be verified through the head coach of that college sport program, cross referencing the individuals name, information and email they provided (i.e., information on the recruiter record 208). As a specific example, in one embodiment, a code is sent to the recruiter's email, asking to verify that code so they can activate their account. In other embodiments, the verification of the individual's role as a legitimate recruiter or scout may be performed using any other means known in the art.

Recruiter users 124 can follow individual players, as well as teams 130. They can see what the player is posting, as well as their social media, giving the recruiter a quick look into who they are at surface level. They can also see the different content posted by each team they follow. In some embodiments, the recruiter record 208 indicates which players and teams are being followed; in other embodiments, the recruiter user 124 may also have a user record 206 that indicates their parameters for these features that may be universal to all user types, as previously discussed.

In some embodiments, the storage 104 may also contain other data objects. Examples include, but are not limited to, media objects 210 (e.g., videos, photos, documents, etc.), school profiles (e.g., a profile for a school having multiple sports programs with independent recruiting programs, etc.), and the like. In some embodiments, there may be a special type of user who has been vetted and trusted to provide accurate live scoring data from a game. Their profile may reflect an additional layer of security, such as a public encryption key, that can be used in conjunction with a private key to encrypt their live scoring data, giving it both protection and authenticity.

In some embodiments, a sporting venue may have one or more cameras with views of the competition area, and the system 100 may be able to access feeds from those cameras over a network 114. This may be advantageous, as cameras placed and/or operated by the sporting venue (e.g., municipal field, school facilities, etc.) can be placed in areas that would otherwise not be available for filming (e.g., a bird's eye view of a football field taken from a lighting stand, an unobstructed behind-the-plate view at a baseball field, etc.). In some embodiments, these cameras may be provided by, and exclusive to, the entity operating the contemplated system 100. The images and video captured could automatically be associated with the relevant teams and players, and accessible through their profiles. In some embodiments, feeds from these cameras may be provided live over the network 114, to the benefit of fans and recruiters. As an option, in some embodiments, additional processing may be performed on the video feeds to enhance them. Examples include, but are not limited to, informational overlays (e.g., live scoring data added to an image as it is received, scoring data applied to stored video after score has been validated, etc.), and visual enhancements (e.g., ball tracking using machine vision, etc.). In some embodiments, the system 100 may also automatically identify excerpts from the feeds, such as highlight videos, action shots, and major events within a game. All this may be stored as various media objects 210, or as enhanced media objects 210, in some embodiments. In other embodiments, this information may be used to train an artificial intelligence to score a sporting event 128, which can then be used to supplement or even replace some or all of the live scoring data provided by users through client devices 112.

In some embodiments, each individual who interacts with or is involved with the system 100 in some manner may have a single profile that is unique to them and the type of user they are, that contains all their information as well as their preferences for the system 100 (e.g., players/teams they are following, password, etc.). In other embodiments, there may be a profile for every relevant user (e.g., player record 202, team record 204, recruiter record 208, etc.) that contains information that is specific to how they are represented within the system 100, in addition to a user record 206 that contains types of information that is universal to all or most (e.g., may exclude system 100 administrators, etc.) users of the system 100. The user record 206 could also be thought of as a fan record or profile, as a fan user 122 would be entirely represented within the storage 104 by such a user record 206, while other user types would have additional records specific to their role in the student athlete recruitment system 100. In these embodiments, the user record 206 may comprise usernames, passwords, teams followed, players followed, and the like. In some embodiments, the user record 206 may also comprise various preferences associated with the client device 112 interface including, but not limited to, preferred interface style (e.g., light mode, dark mode, themed with a team's colors, etc.), preferred statistics (e.g., interface may be configured to only show the particular statistics the user is interested in, or may be configured to hide particular statistics), and the like.

In some embodiments, these user preferences may be stored on the server 102 as a user record 206. In other embodiments, they may be stored locally, on each client device 112 that the user employs to interact with the system 100 (e.g., settings would not carry over from one device to another, etc.). In still other embodiments, the user preferences may be stored in both locations, and synchronized between the system 100 and client device 112 periodically or in response to an event. This mixed local/remote storage arrangement may be beneficial, reducing latency and server load through local storage, and providing consistency and a form of backup through synchronizing with server-stored data.

In some embodiments, the system 100 may store other data, which may be stored in other types of data objects. For example, in some embodiments, the system 100 may store the statistics for previous seasons for players and teams. In some embodiments, this historical data may exist within the system 100 in the same form as current season data, in the form of game data objects 200 that are linked to by team and player objects. In other embodiments, historical data may be stored in the system 100 as a history object, and may contain information of previous seasons which may be reduced to the bare statistics (as opposed to the chronological event-based record produced from live scoring data in some embodiments). This may be advantageous, particularly when onboarding players and teams who have historical data of interest, but were not previously involved with the system 100. Rather than having to recreate game data objects 200 for all those previous seasons, a block of historical statistics may be entered into the system 100 in a more familiar and consolidated form (e.g., box scores in baseball, etc.), and reflected in the player records 202 and team records 204.

As will be discussed below, in some embodiments the leaderboards may be regenerated every time they are requested by a client device 112, by simply passing a query to the storage 104 (i.e., database). In other embodiments, leaderboards may be stored in the storage 104 as a leaderboard object that is updated in response to changes in data elsewhere.

FIG. 3A is a schematic process view of a non-limiting example of a method for facilitating student athlete recruitment by obtaining and validating live scoring data 300. Specifically, FIG. 3A shows a non-limiting example of a method for receiving live scoring data 300, validating it, and making it immediately available to users. The process begins with the receipt of live scoring data 300 by the server 102, in the form of a first message 302 sent by a first user 316a via a first client device 112a communicatively coupled to the server 102 through the network 114. See circle ‘1’.

In the context of the present description and the claims that follow, live scoring data 300 is information describing at least a portion of the events occurring within a sporting event 128. The term “live scoring data” should not be interpreted as having to describe the entire sporting event 128, nor be strictly limited to describing events that have an impact on the score. According to various embodiments, the live scoring data 300 can be as limited as describing a single action or event that occurs within a game that may or may not impact the score. The live scoring data 300 can describe any aspect of the sport that is being tracked by the contemplated system 100. The live scoring data 300 is sent from a location and at a time that is proximate to the sporting event 128 (e.g., right after the action occurs, from the sporting event 128 venue).

According to various embodiments, the first message 302 that comprises the live scoring data 300 is sent from a first client device 112a which is associated with a first user 316a. In the non-limiting example shown in FIG. 3A, the first user 316a is a fan user 122 (e.g., a spectator). In some embodiments, the ability to record and send live scoring data 300 may be extended to all user types, such as fan users 122, recruiter users 124, player users 118, and team users 120. In other embodiments, the submission of live scoring data 300 may be restricted.

In some embodiments, additional user types may exist to provide access to a live scoring interface to school representatives, designated score keepers, league officials, and the like. These users would be able to score events, but would not have the other features common to most other users such as following players and teams, which would not be appropriate for an official scorekeeper or user with a similar role (though they could also have a personal fan account for that purpose).

In some embodiments, the live scoring data 300 (e.g., the first message 302) may be sent immediately, in response to the first client device 112a receiving the input from the first user 316a. In other embodiments, the client device 112 may transmit collected data in a message to the server 102 after a period of time has elapsed, or in response to an event or signal. In still other embodiments, the first message 302 may be manually sent by the first user 316a through the client device 112 interface (e.g., a “send” or “update” button).

In some embodiments, that first message 302 containing live scoring data 300 may be immediately used to update one or more data objects within the storage 104 (e.g., a game data object 200). In other embodiments, the server 102 may perform some form of validation on the live scoring data 300 being received from client devices 112 before allowing it to be reflected in user-facing data, such as the team records 204 and player records 202, or leaderboard 322 queries.

In some embodiments, the validation of the first message 302 may depend upon the identity of the first user 316a (i.e., the user who's client device 112 sent the first message 302). For example, in one embodiment there may be particular types of users (e.g., official scorekeepers, etc.) whose submissions are immediately accepted and incorporated as validated scoring data 310. However, while their impartiality may be assumed, this does not address the potential for errors in entering the live scoring data 300.

In other embodiments, the first message 302 may be validated using a second message 304 received from a second client device 112b through the network 114. See circle ‘2’. The second client device 112b is associated with a second user 316b who is different from the first user 316a. This helps ensure the data is accurate and reliable. See, for example, the second message 304 coming from the second client device 112b associated with a second user 316b (i.e., a team user 120) in the non-limiting example shown in FIG. 3A.

In some embodiments, the second message 304 may comprise an approval 308 of the first message 302. For example, in some embodiments the validation may require input from any team user 120, or even a specific team user 120 such as a coach. The coach or other team user 120 is likely busy with other matters during the sporting event 128 and would not be able to input detailed live scoring data 300 into the second client device 112b. However, if presented with the live scoring data 300 that was received by the server 102 in the first message 302, the team user 120 may be prompted to simply approve (resulting in the transmission of an approval 308 in the second message 304) or disapprove. As an option, the second message 304 may further comprise a reason for disapproval, or even a correction to the live scoring data 300.

In other embodiments, the second message 304 comprises live scoring data 300 representing observations from the second user 316b describing the sporting event 128 that overlap, at least partially, with the live scoring data 300 describing the first user 316a's observations, as recorded in the first message 302. In other words, the first and second messages describe the same event or action within the game, in at least one instance. In some embodiments, the live scoring data 300 found in both messages (i.e., same in-game event or action) may be deemed validated by the server 102 if the two messages agree. In some embodiments, the agreement of two messages may be sufficient for validation. In other embodiments, additional messages from other users may be needed for validation.

According to some embodiments, in cases where the two messages contain live scoring data 300 that is not in agreement, the system 100 may reject that data, and inform the submitting users (i.e., first user 316a and second user 316b) what aspect of their live scoring data 300 was rejected and why. If, upon realizing that they made a mistake, one of the users amends their observations and resubmits data that agrees, the item may be deemed validated.

In some embodiments, until that occurs, or in the event of any unvalidated data being introduced, the game data object 200 (or at least that part of the game data object 200) may be flagged as unvalidated. As an option, a game data object 200 with unvalidated data may produce statistics and information whose lack of validation is visually reflected on every record affected (e.g., an asterisk on affected statistics indicating that they reflect data that hasn't been validated, etc.), but only the particular data involved (e.g., a baseball players fielding statistics may be flagged as in flux while the current game score may be presented as certain, etc.). In other embodiments, the records and queries referencing the game data object 200 are limited to only seeing validated scoring data 310.

In some embodiments, one or more specific users present at the game may be given the power to settle inconsistencies in the live scoring data 300 received from various other users. As a specific example, in one embodiment, the server 102 may be configured to receive live scoring data 300 from a representative of each team 130 playing (i.e., the first and second users are team users 120 from opposing teams 130). Instances of disagreement may be settled by an official scorekeeper or other impartial representative, who may be otherwise observing a subset of the behavior and actions being recorded and reported by the first and second users.

In still other embodiments, disagreements between the first message 302 and second message 304 may be settled through compromise, allowing the mystery to be solved later. For example, in some embodiments the disagreement may be settled using an average of the two observations. As an option, the types of data involved may be flagged on the game data object 200 and reflected in data presented to users until the disagreement is resolved later. In some embodiments, that resolution may be delayed until the end of the game; in other embodiments, the matter may be resolved while the game is still going.

In some embodiments, live scoring data 300 may be validated using information provided by a user based entirely on the identity of said user. In other embodiments, additional validation may be performed. For example, in some embodiments, the server 102 may determine whether the submitting user is actually present at the sporting event 128 they are providing live scoring data 300 for. This may be accomplished in a number of ways.

The live scoring data 300 should be received by the server 102 from a location and at a time that is proximate to the sporting event 128 (e.g., right after the action occurs, from the sporting event 128 venue, etc.). In some embodiments, the client device 112 may attach location data 306 (e.g., the GPS coordinates of the client device 112, etc.) to every live scoring data 300 message (e.g., first message 302, second message 304, etc.) that it sends. This location data 306 may be compared with the known location of the venue where that sporting event 128 is occurring.

In other embodiments, users may prove their attendance at the sporting event 128 by scanning a QR code that is unique to that particular sporting event 128 and displayed at the venue. In still other embodiments, other location-based mechanisms may be used.

If the location data 306 agrees with the known location of the venue, the information provided may proceed to the next stage of its use (e.g., provide live scoring data 300 to the server 102, provide approval 308 to live scoring data 300, etc.). If the location data 306 does not agree, the information may be disregarded and the submitting user informed.

Upon receipt, or once the live scoring data 300 has been deemed ready for incorporation, the server 102 identifies at least one data object within the storage 104 that is associated with the live scoring data 300 received (and validated, in some embodiments). In some embodiments, the at least one data object may comprise at least one of a player record 202, a team record 204, and a game data object 200. In other embodiments, including the non-limiting example shown in FIG. 3A, the server 102 may identify the game data object 200 associated with the sporting event 128 being described by the live scoring data 300. See circle ‘3’.

In some embodiments, the relevant data object may be identified after the receipt of the first message 302, while in other embodiments the identification may not occur until after the first message 302 has been validated (e.g., using a second message 304, etc.). In some embodiments, the live scoring data 300 may be stored in the game data object 200 upon receipt, while in other embodiments the game data object 200 may not be updated until the live scoring data 300 has been validated using any of the methods discussed above.

In some embodiments, the messages from the client devices 112 (e.g., first message 302, second message 304, etc.) may contain information that identifies which specific sporting event 128 they are describing. In some embodiments, the identity of the sporting event 128 may be determined by asking the user when they first start inputting live scoring data 300 (e.g., asking them to verify that they are at the Union Bulldogs vs Jenks Warriors football game at Union High School, etc.). This may be enough to prevent confusion when a venue is hosting multiple games. The user selection, combined with the previously discussed location-based validation (in some embodiments), may be sufficient to identify the appropriate game data object 200. This process (apart from prompting the user to verify their location) may be used with every message, in some embodiments. In other embodiments, after the first interaction leads to the identification of the appropriate game data object 200, the server 102 may send the unique identifier of the game data object 200 (or some other form of identification) back to the client devices 112, to be used with all subsequent messages associated with that game.

As previously discussed, and according to various embodiments, the player records 202 and team records 204 may simply refer to the game data object 200 rather than duplicate the information it contains. When a client device 112 requests a player record 202 or team record 204, or loads a leaderboard 322, the statistics are recalculated using all the data referenced by said record or retrieved by said query 320. This is advantageous over other systems, where data updates take time to be reflected in the statistics. The contemplated system 100 can receive live scoring data 300, and that live scoring data 300 will go directly to the team record 204 and player records 202 (i.e., be reflected in the statistics shown with the team records 204 and player records 202).

One of the exceptions to this is when the game data object 200 does not exist. In some embodiments, one or more team users 120 may submit the information concerning an upcoming game to the system 100, before the game. As an option, user's following a team or a player may be notified that they have an upcoming game, along with the location and time. In other embodiments, an entire season of anticipated games may be entered into the system 100.

In still other embodiments, the game data object 200 may be created by the server 102 within the storage 104 in response to a message from any user that would otherwise be authorized to provide live scoring data 300. The existence of a game may be treated like any other live scoring data 300, meaning it may be verified in the same way any other message would be (e.g., no verification for some users, corroboration required between both teams, etc.). For example, in one embodiment, a user may indicate they are at a game between two teams that they specify in the client device 112. This data is sent to the server 102, which responds with additional data pertinent to the game (e.g., team rosters, etc.). As an option, in some embodiments some users (e.g., a team user 120, a player user 118 on their own behalf, any user authorized to submit live scoring data 300, etc.) may be able to modify the team rosters for a particular game.

Once the server 102 has identified the one or more data objects that will be modified to reflect the live scoring data 300 that has been received (and, in some embodiments, validated), the data object(s) are updated. According to various embodiments, this updating is contemporaneous with the sporting event 128.

In the specific, non-limiting example shown in FIG. 3A, the game data object 200 is updated to include the live scoring data 300 or validated scoring data 310. See circle ‘4’. The contemplated system 100 is advantageous over other systems attempting to provide statistics for student athletes because updating the game data object 200 means that the stats are all up-to-date as of a subsequent request from a client device 112. In some embodiments, the updates may be pushed in real-time to client devices 112 whose interface is showing data that has been changed.

In some embodiments, these changes are seen when the user refreshes their data or reloads the interface. In other embodiments, any changes are immediately sent to user devices that are viewing the affected profiles (e.g., users at the game, fans following from elsewhere, etc.). This may be accomplished using protocols employed for providing real-time or near real-time updates of changing data. These protocols and methods may include, but are not limited to, WebSocket (i.e., protocol providing full-duplex communication for real-time data transfer between client and server), Server-Sent Events or SSE (i.e., pushing real-time updates from a web server to client over HTTP or HTTPS), push notifications (i.e., sending real-time information to devices, even when app isn't running), Google Firebase Cloud Messaging or FCM (i.e., a cloud service for sending notifications and data messages in real-time to client apps), Apache Kafka (i.e., a platform used for high-performance real-time data pipelining and streaming analytics), Socket.IO (i.e., a JavaScript library enabling real-time and bidirectional communication between browser and server), GraphQL subscriptions (i.e., a feature in GraphQL allowing a server to send data to its clients in real-time when a specific event occurs), and the like.

In some embodiments, access to the client device 112 interface for recording live scoring data 300 (which is then sent to the server 102) may be restricted to team user 120 accounts, which may be operated by a coach, assistant coach, manager, and the like. In other embodiments, the ability to submit live scoring data 300 (e.g., send the first message 302, etc.) may be restricted to users specified by a team user 120.

For example, in some embodiments including the non-limiting example shown in FIG. 3A, before the events of ‘circle 1’ the server 102 may receive an authorization message 312 from the second user 316b (i.e., the team user 120) identifying the first user 316a (i.e., a fan user 122) and authorizing the first user 316a to act as a subcoach 314. In the context of the present description and the claims that follow, a subcoach 314 is a user who is not a team user 120 (i.e., not officially associated with the team 130) but has been authorized to provide live scoring data 300 on behalf of the team 130. In some embodiments, this designation of subcoach 314 may be temporary, only lasting until the end of that particular sporting event 128. In other embodiments, a user may be appointed subcoach 314, and remain subcoach 314 until the authorization is revoked by a team user 120.

Once the server 102 has determined that the first user 316a has been authorized to act as the subcoach 314 (e.g., the server 102 has received the authorization message 312, etc.), the server 102 will receive and process live scoring data 300 from the subcoach 314 and only the subcoach 314. In some embodiments, a team user 120 may also submit live scoring data 300. The determination that the live scoring data 300 has been submitted by an authorized subcoach 314 may be considered part of the validation process, according to various embodiments.

In some embodiments, the team user 120 may appoint and authorize multiple subcoaches 314. In other embodiments, a team 130 may be restricted to appointing a single subcoach 314, such that a sporting event 128 may have, at most, two subcoaches at any one time, one appointed by each team 130.

Once the game data object 200 and/or other records have been updated within the storage 104, the added data is immediately reflected in the various interfaces 318 provided by the server 102 to the various client devices 112. As a specific example, in some embodiments including the non-limiting example shown in FIG. 3A, an interface 318 of a third client device 112c (e.g., the smartphone of a recruiter user 124, etc.) is updated to reflect the validated scoring data 310 of the game data object 200 in response to the validation of the live scoring data 300. As previously discussed, in some embodiments that interface 318 may be updated to reflect the validated scoring data 310 in real-time.

FIG. 3B is a schematic process view of a non-limiting example of a method for finalizing scoring data for a sporting event 128. As previously discussed, in some embodiments, the data obtained from the client devices 112 may be validated before being reflected in the data visible to other users. In other embodiments, there may be a second validation or certification after the game is over, to indicate that both teams agree as to what took place, and that the data within the game data object 200 is accurate. This second validation is hereinafter referred to as the finalization of the scoring data. The contemplated process of verification and agreement between parties whose interests are somewhat contrary may serve to increase the trust a recruiter user 124 places in the information provided by the system 100, particularly when the recruiter user 124 is not able to attend the game or games reflected by the statistics.

In some embodiments, each team 130 may be scoring the sporting event 128 (e.g., each team 130 represented by a subcoach 314 who submits live scoring data 300 that is validated by a team user 120 for the respective teams 130, etc.). In other embodiments, only one team 130 needs to score the sporting event 128, and the other team 130 may simply agree or disagree with their final data. In either case, the process of finalization begins with the server 102 receiving a first finalizing message 326 from a first team user 120a (e.g., the coach of the first team 130a). See ‘circle 1’. The server 102 then receives a second finalizing message 328 from a second team user 120b (e.g., the coach of the second team 130b). See ‘circle 2’.

The first finalizing message 326 comprises live scoring data 300 that describes at least the end of the sporting event 128. In some embodiments, it may describe the sporting event 128 in its entirety. As a specific example, in one embodiment, the first team user 120a may be presented with a compiled summary of all the validated scoring data 310 provided on behalf of the first team 130a using any of the methods discussed above. The first team user 120a may simply approve or modify this summary, the result being submitted to the server 102 as the first finalizing message 326.

In some embodiments, the second finalizing message 328 may also comprise live scoring data 300 like the first finalizing message 326, except the live scoring data 300 was observed by the subcoach 314 of the second team 130b and validated by the second team user 120b. In other embodiments, the second finalizing message 328 may simply agree or disagree with the first finalizing message 326.

Upon receipt of the first finalizing message 326 and the second finalizing message 328, the server 102 determines what the settled description and outcome of the sporting event 128 will be. See ‘circle 3’. In some embodiments, the server 102 may simply average what is described by the two finalizing messages, and propose the result to the two teams as a settled outcome. The closer the two assessments of the sporting event 128 (e.g., statistics, scores, events, etc.), the closer the average will be to what each team 130 submitted as a finalization message. As an option, either team may be able to dispute this averaged result, according to various embodiments.

In some embodiments, continued disagreements may be settled by an impartial third party (e.g., game official, representative of the contemplated system 100 with access to footage of the game, etc.). In other embodiments, such disputes may “crowdsource” the resolution, relying on the input of as many users present at the game as possible, to resolve disagreements that otherwise would remain unresolved. In still other embodiments, the final certification of the live scoring data 300 may be performed by the server 102, after the fact, using video feeds of the game and analysis through machine vision. Finally, the finalized scoring data 324 is stored within the game data object 200. See ‘circle 4’.

FIG. 3C is a schematic process view of a non-limiting example of a method for providing a real-time leaderboard 322 to an interface 318 on a client device 112. In the context of the present description and the claims that follow, a leaderboard 322 is a condensed ranking of players and teams based on the criteria of a query 320. In some embodiments, the query 320 may be defined by selections made from a predefined set of options (e.g., position, stat category, geographic area, etc.). In other embodiments, the search may include a more freeform input, functioning as a filter. This may be especially useful for a recruiter user 124, who may, for example, want to see a leaderboard 322 of all players with values for a specific statistic that are above a particular number.

In some embodiments, all users have access to the same leaderboards 322. In other embodiments, recruiter users 124 may have access to leaderboards 322 with expanded scope and/or greater granularity. As an option, in some embodiments, team users 120 and individual player users 118 that are playing a game that is receiving live scoring at that moment may be visually distinguished from the other teams/players (e.g., italicized, etc.), so users can monitor the live scoring as it comes in, or to make them aware of potential changes in that entity's statistics.

As previously discussed, in some embodiments the leaderboards 322 may be stored as discrete data objects within the storage 104, periodically updated. However, in other embodiments including the non-limiting example shown in FIG. 3C, the leaderboards 322 may be produced using the latest data in response to any request for the leaderboard 322, acting as the response to a database query 320. This ensures that the leaderboards 322 are always up-to-date with the latest information, including information from a game that is not over yet.

First, the leaderboard 322 is requested by a third client device 112c associated with a user (e.g., a recruiter user 124, as shown in FIG. 3C). This is done by submitting a query 320 to the server 102 that defines the parameters for the leaderboard 322. See ‘circle 1’.

The query 320 is then run over at least a subset of team records 204 and/or player records 202 within the storage 104. See ‘circle 2’. The team records 204 and/or player records 202 are identified using the query 320, and then the desired statistics are derived, at least in part, from the game data objects 200 referenced in said team records 204 and/or player records 202. In some embodiments, some of the requested data may be stored in the team records 204 and/or player records 202 (e.g., historical data, etc.).

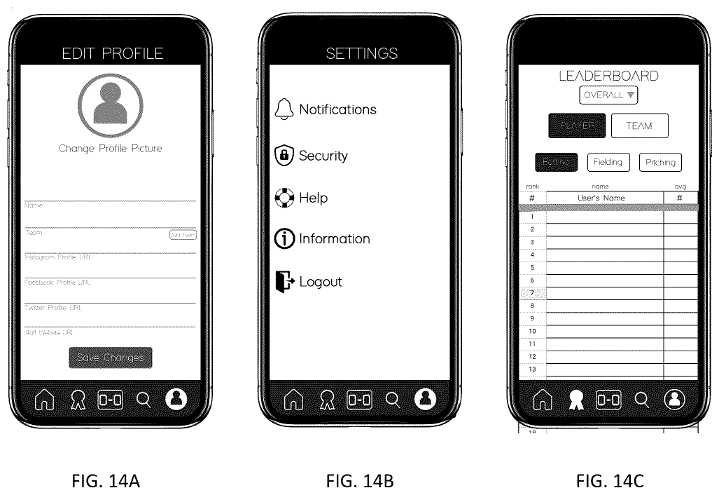

The server 102 extracts the relevant data from the identified team records 204 and/or player records 202 and applies the query 320 to narrow down the information into the requested leaderboard 322. The server 102 then sends the leaderboard 322 to an interface 318 on the third client device 112c, for display. See ‘circle 3’. Leaderboards 322 will be discussed in greater detail in the context of FIGS. 14C-18C, below.

FIGS. 4A-30B are various views of a non-limiting example of the user interfaces of a mobile application running on a client device 112. They illustrate various functionalities, including some of the functionalities discussed above. It should be noted that these examples are non-limiting. The functionalities depicted may be implemented in other ways in other embodiments, or may be omitted altogether. In still other embodiments, the interface with the system 100 may include features or provide functionalities disclosed herein that are not depicted in FIGS. 4A-30B. It should also be noted that FIGS. 4A-30B are showing views of a system 100 that is directed specifically at softball. Other embodiments may feature different or additional sports, or may include other facets, statistics, or other information that is not featured in these non-limiting examples.

FIGS. 4A-7A illustrate parts of a non-limiting example of the onboarding process, where accounts are created and profiles/records are populated. FIG. 4A shows the various types of user accounts, according to some embodiments. FIGS. 4C-6C show examples of the types of information that may be requested from fans, players, teams, and recruiters.

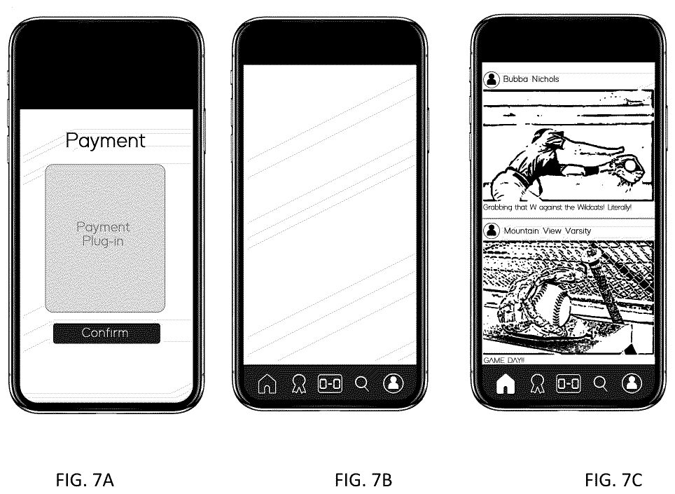

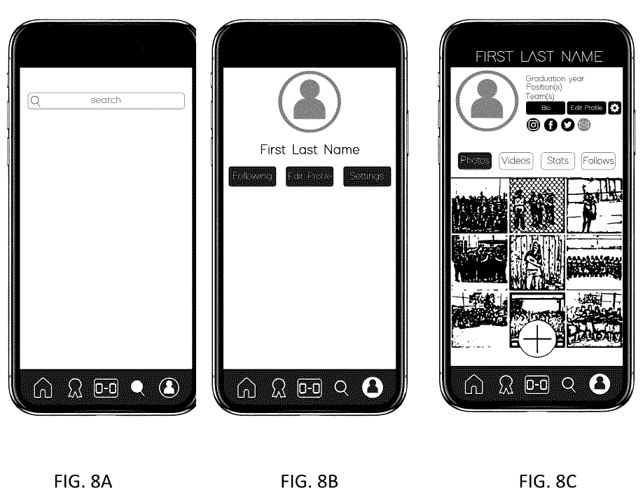

FIGS. 7B-8B show non-limiting examples of some of the basic user interface elements, with buttons along the bottom of the screen leading to an account home, leader boards, live scoring, search, and accounts followed pages, respectively. FIG. 7C shows a feed, containing recent posts and media from players, teams, and recruiters that are being followed. According to various embodiments, users can search for teams and players; searches may be against various attributes which may include name, location, position, sport, and the like.

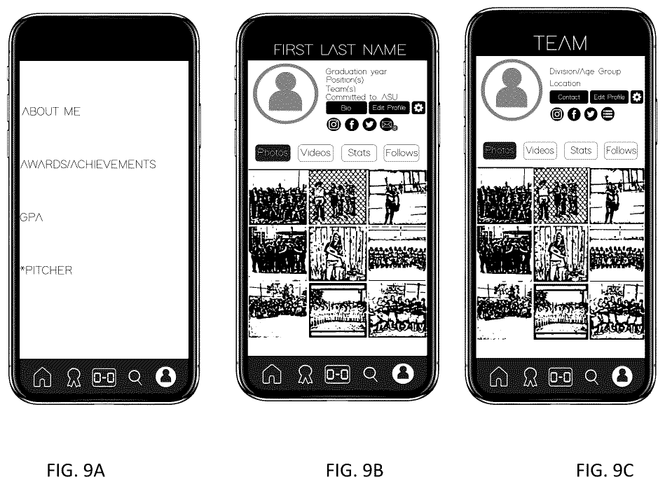

FIGS. 8C-9B show non-limiting examples of a player summary. According to various embodiments, a player summary may comprise a bio (FIG. 9A), links to social media accounts, email (or messaging contained to the system 100 to preserve the privacy of a player's email address), photos, videos, statistics, and information on who is following them, and who they follow. When a player visits their own summary, they may be presented with the option to edit their profile. The player's summary will have the ability to post photos and videos of themselves, or anything they think may be beneficial for them. These photos and videos will be used to attract recruiters, showcasing themselves.

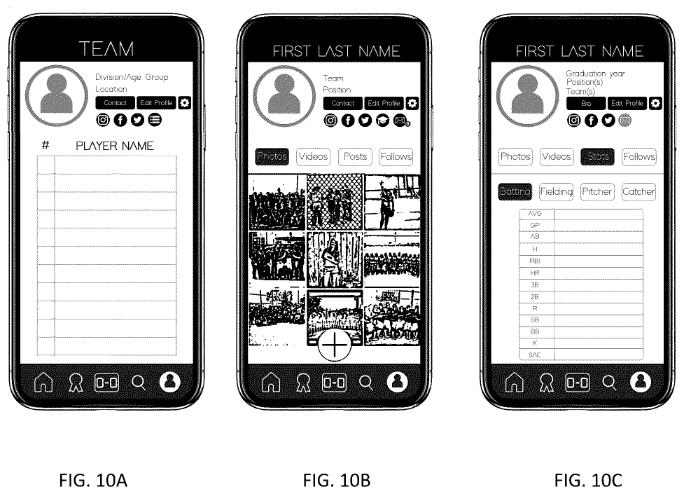

FIGS. 9C-10B show a non-limiting examples of a team summary. According to various embodiments, a team summary may comprise links for contact as well as social media, along with photos, videos, statistics, and a list of follows and followers. The team's summary will have the ability to post photos and videos of their team, spotlighting their triumphs, good plays, and MVPs from games. The team summary also includes a team roster (FIG. 10A), which may link to the summaries of individual players (FIG. 10B).

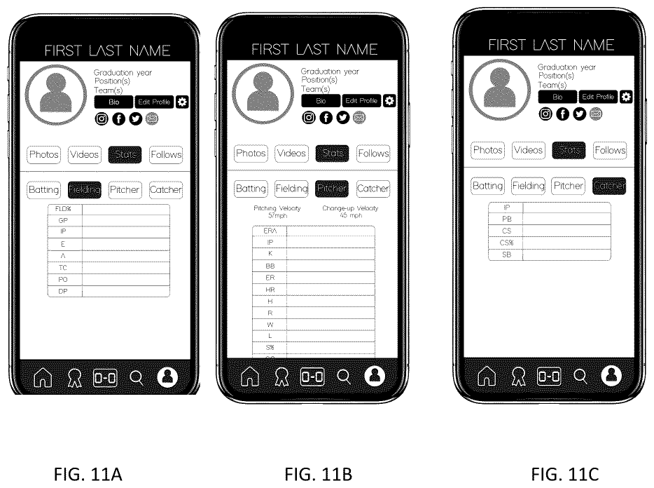

FIGS. 10C-11C show non-limiting examples of interfaces for the statistics for an individual player. As a reminder, this non-limiting example is directed toward softball; other embodiments may include different or additional sports. According to various embodiments, the player statistics may be broken down into categories. For example, in this softball-focused embodiment, the player's statistics are grouped by batting (FIG. 10C), fielding (FIG. 11A), pitching (FIG. 11B), and catching (FIG. 11C). Within those categories, a multitude of statistics may be tracked and displayed. The statistics a player receives from live scoring go directly into their individual statistics.

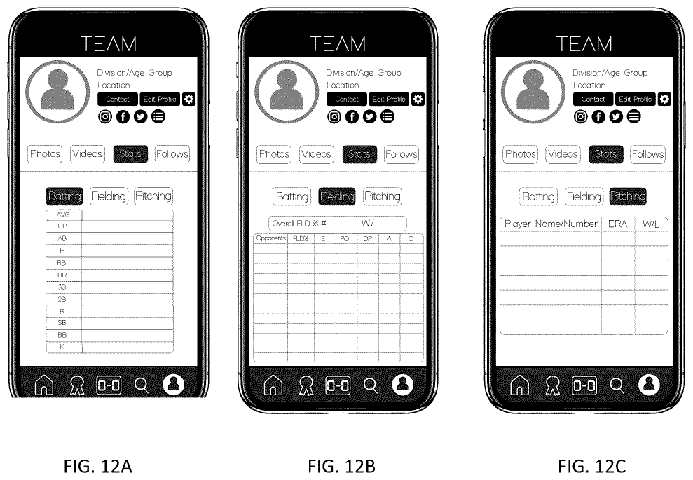

FIGS. 12A-12C show non-limiting examples of interfaces for the statistics for a team. Depending on the sport, team statistics may be very different than individual statistics. In some embodiments, the team statistics are grouped in categories such as batting (FIG. 12A), fielding (FIG. 12B), and pitching (FIG. 12C). As shown in FIG. 12C, some team statistics may be broken down by individual player, here being the teams' pitchers. As an option, player breakdowns like this may link directly back to the player summaries.

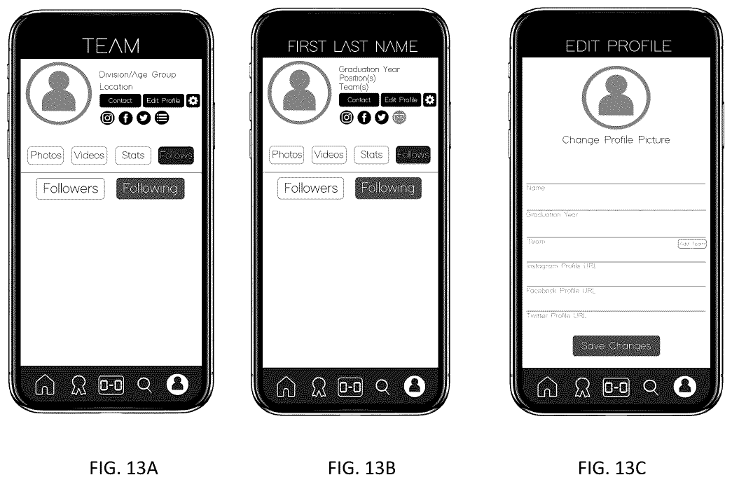

FIGS. 13A and 13B show that the team and player summaries may both indicate who is following them, and who they are following. In other embodiments, some or all of this information may be visible to only a subset of users (e.g., only that user, that user and all recruiters, that user and who they are following, etc.).

FIG. 13C shows a non-limiting example of how a user may edit their profile, adding or changing information as needed. FIG. 14A shows a recruiter editing their profile. FIG. 14B shows additional features and settings available to the users, as is known in the art.

FIGS. 14C-18C show various views of non-limiting examples of the different leaderboards. The leaderboard is a condensed ranking of players and teams based on the criteria of a search. In some embodiments, the search is defined by selections made from a predefined set of options (e.g., position, stat category, geographic area, etc.). In other embodiments, the search may include a more freeform input, functioning as a filter. This may be especially useful for a recruiter, who may, for example, want to see a leaderboard of all players with values for a specific statistic that are above a particular number. In some embodiments, all users have access to the same leaderboards. In other embodiments, recruiters may have access to leaderboards with expanded scope and/or greater granularity. As an option, in some embodiments, teams and individual players that are playing a game that is receiving live scoring at that moment may be visually distinguished from the other teams/players (e.g., italicized, etc.), so users can monitor the live scoring as it comes in, or to make them aware of potential changes in that entity's statistics.

As shown, players and teams can be ranked by any statistic that is tracked among them (e.g., batting average, fielding average, ERA, etc.). In some embodiments, if the user looking at the leaderboard is a player user 118 or a team user 120, their position in the leaderboard may be listed at the top, independent of their ranking, making it easier to compare.

As previously discussed, in some embodiments, the leaderboards may be regenerated in response to any request for the leaderboard, acting as the response to a database query. This ensures that the leaderboards are always up-to-date with the latest information, including information from a game that is not over yet. In other embodiments, one or more of the leaderboards may be stored as, and updated like, a data object within the storage 104.

In some embodiments, the leaderboards may be filtered by school district or club divisions (e.g., age bracket, team status, etc.). In some embodiments, the filtering may also include graduation year, position, and the like. In some embodiments, these filters are available to all users, while in other embodiments some or all these filters may be exclusively used by recruiters, allowing them to narrow down their search for a player based on more specific information.

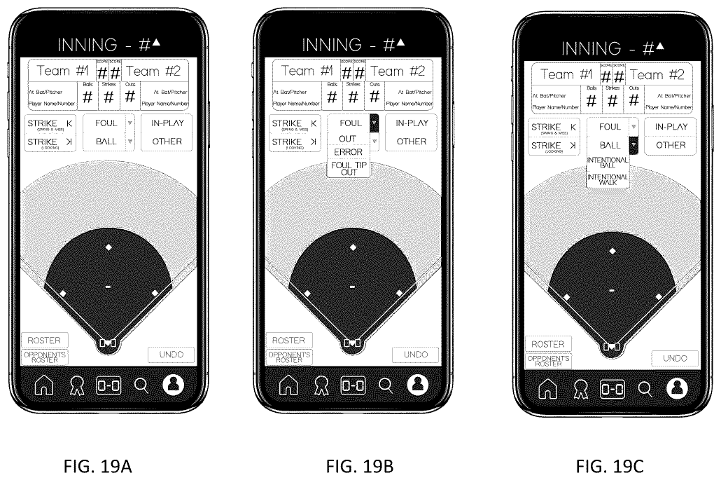

FIGS. 19A-30B show non-limiting examples of various user interfaces used for live scoring of a softball game. Other embodiments that cover different or additional sports would of course have drastically different interfaces. In some embodiments, the live scoring interfaces for some sports (e.g., baseball, softball, soccer, football, volleyball, etc.) may resemble the field of play, like the non-limiting examples shown in FIGS. 19A-30B. In other sports, particularly sports with a variety of events happening simultaneously (e.g., track and field, gymnastics, etc.), the live scoring interface may be more like a table or spreadsheet.

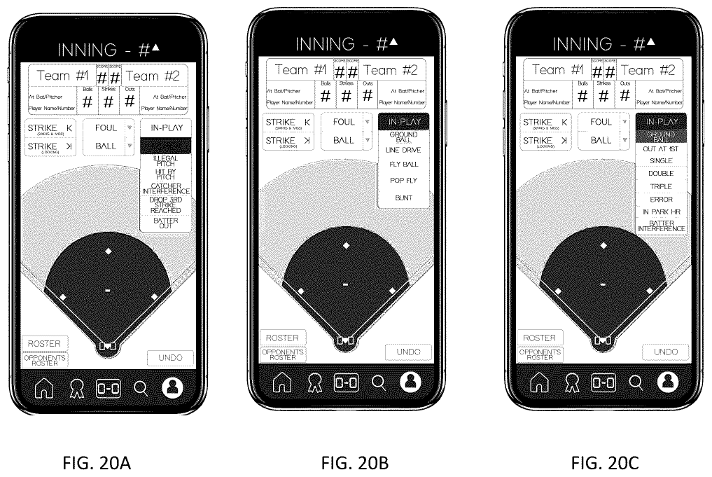

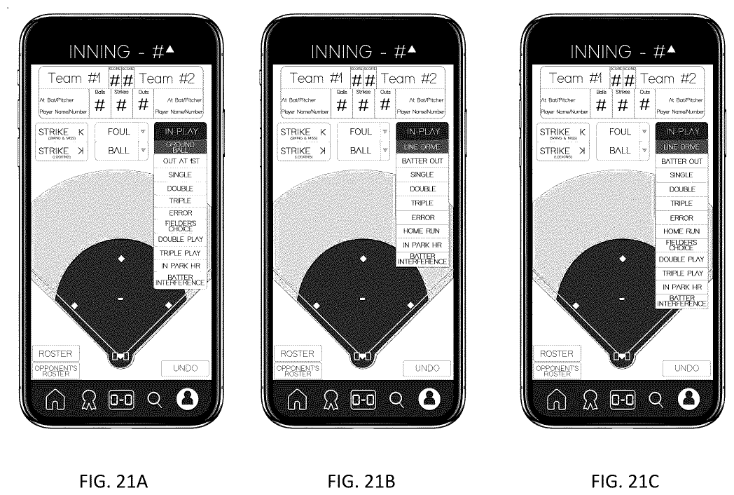

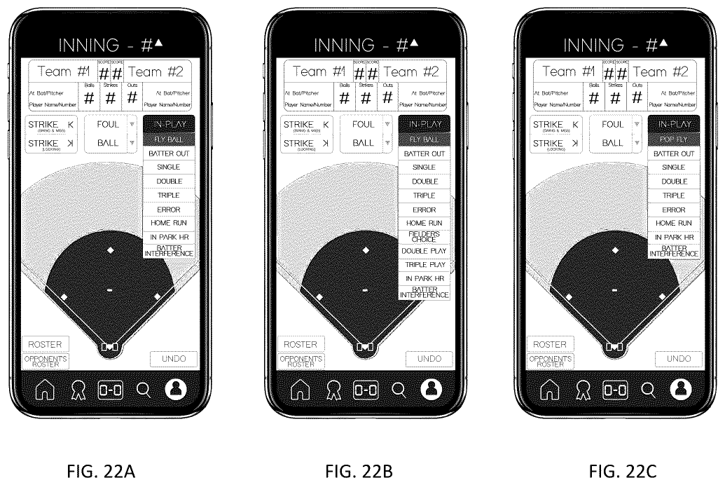

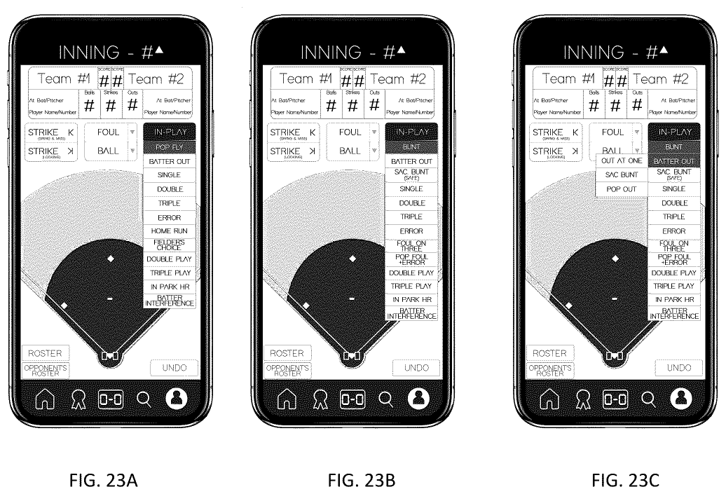

As shown, the live scoring may be configured to record a wide range of events that may occur during a game. In some embodiments, including the non-limiting example shown in FIGS. 19A-30B, the interface may present a series of branching menus, to organize this large collection of events. For example, as shown, this non-limiting example of an interface for live scoring of a softball game organizes events, such as “In-Play” events (FIG. 20B), into categories (e.g., “Ground Ball”-FIG. 20C, “Line Drive”-FIG. 21B, “Fly Ball”-FIG. 22A, “Pop Fly”-FIG. 22C, “Bunt”-FIG. 23B), and each of those categories into subcategories (e.g., Batter Out, Single, Double, Triple, Error, Home Run, In Park HR, Batter Interference-all stemming from “In-Play”->“Line Drive”). These events may describe the actions of various positions at the same time (e.g., pitching data along with batting data and fielding data, etc.)

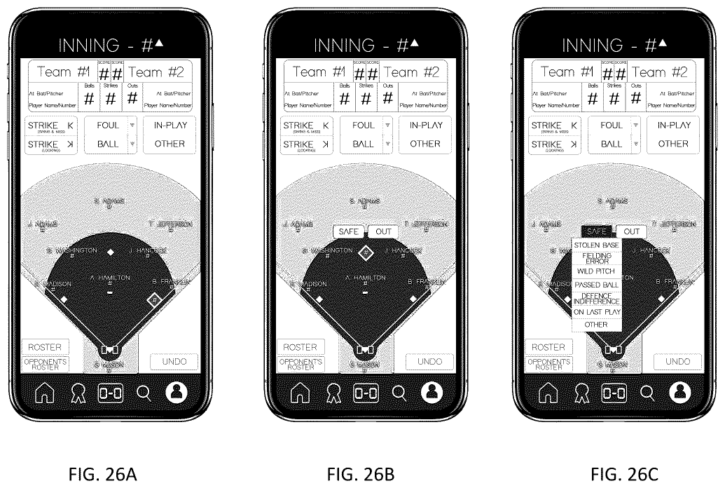

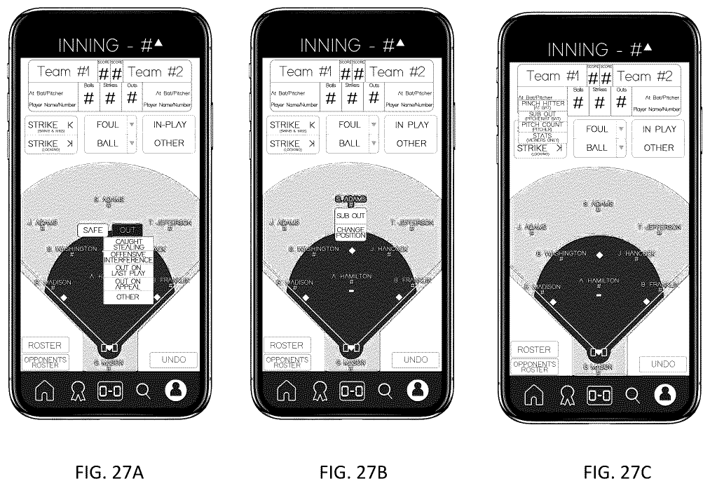

In some embodiments, the live scoring interface may also allow the user providing the scoring to give an event context. See, for example, FIG. 26B, which shows a base runner on second being declared safe, with a specified reason (FIG. 26C). Other game events may be recorded, such as substitutions (FIG. 27B).

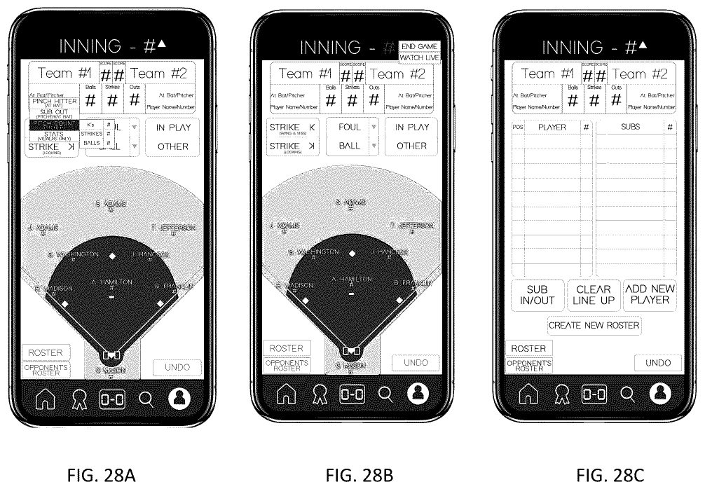

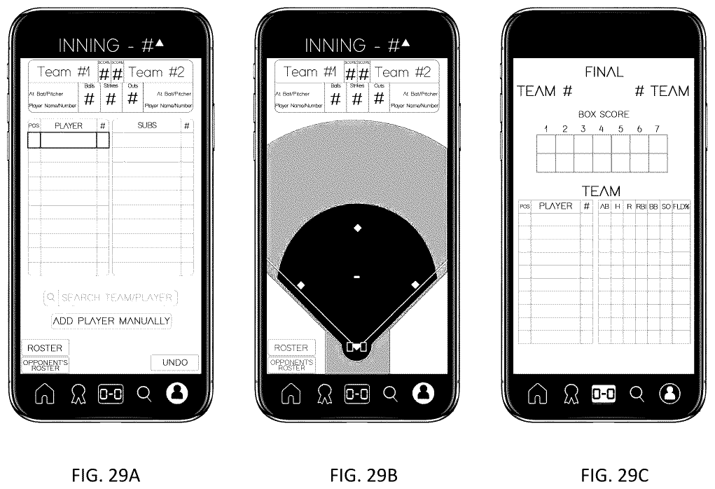

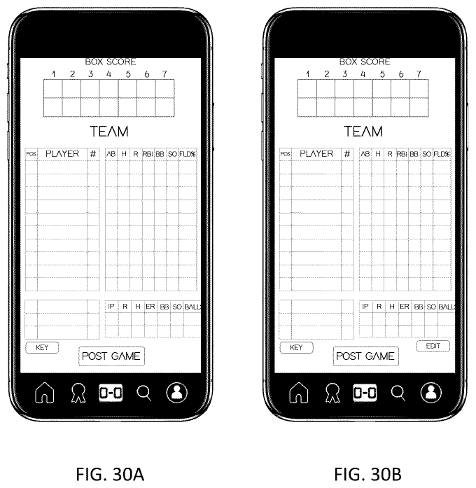

Each game data object 200 may comprise a roster of all participating players. In some embodiments, a live scoring user may enter and edit this roster through their client device 112, as shown in FIGS. 28C and 29A. In some embodiments, some users may be limited to seeing the live scoring, rather than being able to enter it (See FIG. 29B). Once the game is over, a final summary (e.g., box score) is available (FIGS. 29C-30B).

FIG. 31 is a schematic diagram of specific computing device 3100 and a specific mobile computing device 3150 that can be used to perform and/or implement any of the implementations disclosed herein. In one or more implementations, the server 102, storage 104, and/or client devices 112 of FIG. 1 may be the specific computing device 3100. Additionally, one or more of the client devices 112 of FIG. 1 may be the specific mobile computing device 3150.

The specific computing device 3100 may represent various forms of digital computers, such as laptops, desktops, workstations, personal digital assistants, servers, blade servers, mainframes, and/or other appropriate computers. The specific mobile computing device 3150 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the implementations described and/or claimed, according to one implementation.

The specific computing device 3100 may include a processor 3102, a memory 3104, a storage device 3106, a high speed interface 3108 coupled to the memory 3104 and a plurality of high speed expansion ports 3110, and a low speed interface 3112 coupled to a low speed bus 3114 and a storage device 3106. In one implementation, each of the components heretofore may be inter-coupled using various buses, and may be mounted on a common motherboard and/or in other manners as appropriate. The processor 3102 may process instructions for execution in the specific computing device 3100, including instructions stored in the memory 3104 and/or on the storage device 3106 to display a graphical information for a GUI on an external input/output device, such as a display unit 3116 coupled to the high speed interface 3108, according to one implementation.

In other implementations, multiple processors and/or multiple buses may be used, as appropriate, along with multiple memories and/or types of memory. Also, a plurality of specific computing device 3100 may be coupled with, with each device providing portions of the necessary operations (e.g., as a server bank, a group of blade servers, and/or a multi-processor system).

The memory 3104 may be coupled to the specific computing device 3100. In one implementation, the memory 3104 may be a volatile memory. In another implementation, the memory 3104 may be a non-volatile memory. The memory 3104 may also be another form of computer-readable medium, such as a magnetic and/or an optical disk. The storage device 3106 may be capable of providing mass storage for the specific computing device 3100. In one implementation, the storage device 3106 may be includes a floppy disk device, a hard disk device, an optical disk device, a tape device, a flash memory and/or other similar solid state memory device. In another implementation, the storage device 3106 may be an array of the devices in a computer-readable medium previously mentioned heretofore, computer-readable medium, such as, and/or an array of devices, including devices in a storage area network and/or other configurations.

A computer program may be comprised of instructions that, when executed, perform one or more methods, such as those described above. The instructions may be stored in the memory 3104, the storage device 3106, a memory coupled to the processor 3102, and/or a propagated signal.

The high speed interface 3108 may manage bandwidth-intensive operations for the specific computing device 3100, while the low speed interface 3112 may manage lower bandwidth-intensive operations. Such allocation of functions is exemplary only. In one implementation, the high speed interface 3108 may be coupled to the memory 3104, the display unit 3116 (e.g., through a graphics processor and/or an accelerator), and to the plurality of high speed expansion ports 3110, which may accept various expansion cards.

In the implementation, the low speed interface 3112 may be coupled to the storage device 3106 and the low speed bus 3114. The low speed bus 3114 may be comprised of a wired and/or wireless communication port (e.g., a Universal Serial Bus (“USB”), a Bluetooth® port, an Ethernet port, and/or a wireless Ethernet port). The low speed bus 3114 may also be coupled to the scan unit 3128, a printer 3126, a keyboard, a mouse 3124, and a networking device (e.g., a switch and/or a router) through a network adapter.

The specific computing device 3100 may be implemented in several different forms, as shown in the figure. In one implementation, the specific computing device 3100 may be implemented as a standard server 3118 and/or a group of such servers. In another implementation, the specific computing device 3100 may be implemented as part of a rack server system 3122. In yet another implementation, the specific computing device 3100 may be implemented as a general computer 3120 such as a laptop or desktop computer. Alternatively, a component from the specific computing device 3100 may be combined with another component in a specific mobile computing device 3150. In one or more implementations, an entire system may be made up of a plurality of specific computing device 3100 and/or a plurality of specific computing device 3100 coupled to a plurality of specific mobile computing device 3150.

In one implementation, the specific mobile computing device 3150 may include a mobile compatible processor 3152, a mobile compatible memory 3154, and an input/output device such as a mobile display 3166, a communication interface 3172, and a transceiver 3158, among other components. The specific mobile computing device 3150 may also be provided with a storage device, such as a microdrive or other device, to provide additional storage. In one implementation, the components indicated heretofore are inter-coupled using various buses, and several of the components may be mounted on a common motherboard.

The mobile compatible processor 3152 may execute instructions in the specific mobile computing device 3150, including instructions stored in the mobile compatible memory 3154. The mobile compatible processor 3152 may be implemented as a chipset of chips that include separate and multiple analog and digital processors. The mobile compatible processor 3152 may provide, for example, for coordination of the other components of the specific mobile computing device 3150, such as control of user interfaces, applications run by the specific mobile computing device 3150, and wireless communication by the specific mobile computing device 3150.

The mobile compatible processor 3152 may communicate with a user through the control interface 3156 and the display interface 3164 coupled to a mobile display 3166. In one implementation, the mobile display 3166 may be a Thin-Film-Transistor Liquid Crystal Display (“TFT LCD”), an Organic Light Emitting Diode (“OLED”) display, and another appropriate display technology. The display interface 3164 may comprise appropriate circuitry for driving the mobile display 3166 to present graphical and other information to a user. The control interface 3156 may receive commands from a user and convert them for submission to the mobile compatible processor 3152.

In addition, an external interface 3162 may be provide in communication with the mobile compatible processor 3152, so as to enable near area communication of the specific mobile computing device 3150 with other devices. External interface 3162 may provide, for example, for wired communication in some implementations, or for wireless communication in other implementations, and multiple interfaces may also be used.

The mobile compatible memory 3154 may be coupled to the specific mobile computing device 3150. The mobile compatible memory 3154 may be implemented as a volatile memory and a non-volatile memory. The expansion memory 3178 may also be coupled to the specific mobile computing device 3150 through the expansion interface 3176, which may comprise, for example, a Single In Line Memory Module (“SIMM”) card interface. The expansion memory 3178 may provide extra storage space for the specific mobile computing device 3150, or may also store an application or other information for the specific mobile computing device 3150.

Specifically, the expansion memory 3178 may comprise instructions to carry out the processes described above. The expansion memory 3178 may also comprise secure information. For example, the expansion memory 3178 may be provided as a security module for the specific mobile computing device 3150, and may be programmed with instructions that permit secure use of the specific mobile computing device 3150. In addition, a secure application may be provided on the SIMM card, along with additional information, such as placing identifying information on the SIMM card in a non-hackable manner.

The mobile compatible memory may include a volatile memory (e.g., a flash memory) and a non-volatile memory (e.g., a non-volatile random-access memory (“NVRAM”)). In one implementation, a computer program comprises a set of instructions that, when executed, perform one or more methods. The set of instructions may be stored on the mobile compatible memory 3154, the expansion memory 3178, a memory coupled to the mobile compatible processor 3152, and a propagated signal that may be received, for example, over the transceiver 3158 and/or the external interface 3162.

The specific mobile computing device 3150 may communicate wirelessly through the communication interface 3172, which may be comprised of a digital signal processing circuitry. The communication interface 3172 may provide for communications using various modes and/or protocols, such as, a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol.

Such communication may occur, for example, through the transceiver 3158 (e.g., radio-frequency transceiver). In addition, short-range communication may occur, such as using a Bluetooth®, Wi-Fi, and/or other such transceiver. In addition, a GPS (“Global Positioning System”) receiver module 3174 may provide additional navigation-related and location-related wireless data to the specific mobile computing device 3150, which may be used as appropriate by a software application running on the specific mobile computing device 3150.

The specific mobile computing device 3150 may also communicate audibly using an audio codec 3160, which may receive spoken information from a user and convert it to usable digital information. The audio codec 3160 may likewise generate audible sound for a user, such as through a speaker (e.g., in a handset smartphone of the specific mobile computing device 3150). Such a sound may comprise a sound from a voice telephone call, a recorded sound (e.g., a voice message, a music files, etc.) and may also include a sound generated by an application operating on the specific mobile computing device 3150.

The specific mobile computing device 3150 may be implemented in a number of different forms, as shown in the figure. In one implementation, the specific mobile computing device 3150 may be implemented as a smartphone 3168. In another implementation, the specific mobile computing device 3150 may be implemented as a personal digital assistant (“PDA”). In yet another implementation, the specific mobile computing device, 3150 may be implemented as a tablet device 3170.

Various implementations of the systems and techniques described here can be realized in a digital electronic circuitry, an integrated circuitry, a specially designed application specific integrated circuits (“ASICs”), a piece of computer hardware, a firmware, a software application, and a combination thereof. These various implementations can include implementation in one or more computer programs that are executable and/or interpretable on a programmable system including one programmable processor, which may be special or general purpose, coupled to receive data and instructions from, and to transmit data and instructions to, a storage system, one input device, and at least one output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal (“LCD”) monitor) for displaying information to the user and a keyboard and a mouse by which the user can provide input to the computer. Other kinds of devices can be used to provide for interaction with a user as well; for example, feedback provided to the user can be any form of sensory feedback (e.g., visual feedback, auditory feedback, and/or tactile feedback) and input from the user can be received in any form, including acoustic, speech, and/or tactile input.

The systems and techniques described here may be implemented in a computing system that includes a back end component (e.g., as a data server), a middleware component (e.g., an application server), a front end component (e.g., a client computer having a graphical user interface, and/or a Web browser through which a user can interact with an implementation of the systems and techniques described here), and a combination thereof. The components of the system may also be coupled through a communication network.

The communication network may include a local area network (“LAN”) and a wide area network (“WAN”) (e.g., the Internet). The computing system can include a client and a server. In one implementation, the client and the server are remote from each other and interact through the communication network.

A number of implementations have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

It will be understood that implementations are not limited to the specific components disclosed herein, as virtually any components consistent with the intended operation of a system and method for facilitating student athlete recruitment may be utilized. Accordingly, for example, although particular systems, methods, and/or devices for validating data, providing real-time updates, authentication, and communication may be disclosed, such components may comprise any shape, size, style, type, model, version, class, grade, measurement, concentration, material, weight, quantity, and/or the like consistent with the intended operation of a system and method for facilitating student athlete recruitment may be used. In places where the description above refers to particular implementations of a system and method for facilitating student athlete recruitment, it should be readily apparent that a number of modifications may be made without departing from the spirit thereof and that these implementations may be applied to other sport monitoring and promotion systems.

What is claimed is:

1. A system for facilitating student athlete recruitment, comprising:
a server having a processor that is communicatively coupled to a memory, a storage, and a network interface, the network interface communicatively coupled to a network, and the server configured to:
receive a first message from a first client device communicatively coupled to the server through the network, the first client device associated with a first user, the first user being one of a player user, a team user, a recruiter user, and a fan user, the first message comprising live scoring data describing a sporting event;
identify a game data object within the storage that is associated with the sporting event being described in the first message, the game data object being referenced by at least one of a player record and a team record;
update the game data object to reflect the live scoring data;
receive a second message from a second client device communicatively coupled to the server through the network, the second client device associated with a second user different from the first user, the second message comprising an approval of the first message or live scoring data describing the sporting event that overlaps, at least in part, with the live scoring data of the first message;
validate the live scoring data associated with both the first message and the second message upon determination that the second message is in agreement with the live scoring data belonging to the first message; and
update the game data object to include validated scoring data;
wherein updating the game data object occurs contemporaneous with the sporting event.

2. The system of claim 1, wherein the at least one of a player record and a team record referencing the game data object only refers to validated scoring data.

3. The system of claim 1, wherein an interface of a third client device is updated to reflect the validated scoring data of the game data object in response to the validation of the live scoring data.

4. The system of claim 3, wherein the interface of the third client device is updated to reflect the validated scoring data in real-time.

5. The system of claim 1:
wherein the server is further configured to receive an authorization message from the second user identifying the first user and authorizing the first user to act as a subcoach;
wherein validating the live scoring data associated with both the first message and the second message further comprises determining that the first user has been authorized to act as the subcoach and also determining that the second user is a team user.

6. The system of claim 5:
wherein the sporting event involves a first team and a second team; and
wherein the server is configured to only allow a single subcoach to be authorized by each team at a time, and wherein the authorization for the subcoach is only valid for that sporting event;
wherein the server is further configured to:
receive and validate live scoring data from client devices associated with the first team and a subcoach authorized by the first team;
receive and validate live scoring data from client devices associated with the second team and a subcoach authorized by the second team; and
finalize the validated scoring data as finalized scoring data when the sporting event has concluded, the finalized scoring data being an average of the validated scoring data validated by the first team and the validated scoring data validated by the second team.

7. The system of claim 1, wherein the server is further configured to:
provide a leaderboard to an interface of a third client device, the leaderboard returned by a query over at least a subset of team records and player records within the storage and comprising at least a portion of the validated scoring data belonging to the game data object, while the sporting event is occurring; and
update the leaderboard on the interface of the third client device to reflect the validated scoring data in real-time.

8. The system of claim 1:
wherein the first message comprises a location data associated with the first client device;
wherein the server is further configured to confirm the first user is present at the sporting event using the location data associated with the first client device.

9. A system for facilitating student athlete recruitment, comprising:
a server having a processor that is communicatively coupled to a memory, a storage, and a network interface, the network interface communicatively coupled to a network, and the server configured to:
receive a first message from a first client device communicatively coupled to the server through the network, the first client device associated with a first user, the first user being one of a player user, a team user, a recruiter user, and a fan user, the first message comprising live scoring data describing a sporting event;
identify a game data object within the storage that is associated with the sporting event being described in the first message, the game data object being referenced by at least one of a player record and a team record; and
update the game data object to reflect the live scoring data.

10. The system of claim 9, wherein the server is further configured to:
receive a second message from a second client device communicatively coupled to the server through the network, the second client device associated with a second user different from the first user, the second message comprising an approval of the first message or live scoring data describing the sporting event that overlaps, at least in part, with the live scoring data of the first message;
validate the live scoring data associated with both the first message and the second message upon determination that the second message is in agreement with the live scoring data belonging to the first message; and
update the game data object to include validated scoring data.

11. The system of claim 10, wherein the at least one of a player record and a team record referencing the game data object only refers to validated scoring data.

12. The system of claim 10, wherein an interface of a third client device is updated to reflect the validated scoring data of the game data object in response to the validation of the live scoring data.

13. The system of claim 12, wherein the interface of the third client device is updated to reflect the validated scoring data in real-time.

14. The system of claim 10:
wherein the server is further configured to receive an authorization message from the second user identifying the first user and authorizing the first user to act as a subcoach;
wherein validating the live scoring data associated with both the first message and the second message further comprises determining that the first user has been authorized to act as the subcoach and also determining that the second user is a team user.

15. The system of claim 14, wherein the server is configured to only allow a single subcoach to be authorized by a team at a time, and wherein the authorization for the subcoach is only valid for that sporting event.

16. The system of claim 14:
wherein the sporting event involves a first team and a second team;
wherein the server is configured to:
receive and validate live scoring data from client devices associated with the first team and a subcoach authorized by the first team;
receive and validate live scoring data from client devices associated with the second team and a subcoach authorized by the second team; and
finalize the validated scoring data as finalized scoring data when the sporting event has concluded, the finalized scoring data being an average of the validated scoring data validated by the first team and the validated scoring data validated by the second team.

17. The system of claim 10, wherein the server is further configured to provide a leaderboard to an interface of a third client device, the leaderboard returned by a query over at least a subset of team records and player records within the storage and comprising at least a portion of the validated scoring data belonging to the game data object, while the sporting event is occurring.

18. The system of claim 17, wherein the interface of the third client device is updated to reflect the validated scoring data in real-time.

19. The system of claim 9, wherein updating the game data object occurs contemporaneous with the sporting event.

20. The system of claim 9:
wherein the first message comprises a location data associated with the first client device;
wherein the server is further configured to confirm the first user is present at the sporting event using the location data associated with the first client device.
